(19) United States
(12) Patent Application Publication
(10) Pub. No.: US 2026/0148103 A1
(43) Pub. Date: May 28, 2026

(54) UPLOAD-DRIVEN AUTOMATIONS FOR CONTENT ITEMS

(71) Applicant: Dropbox, Inc., San Francisco, CA (US)

(72) Inventors: Lawrence Ntim, Los Angeles, CA (US); Jode-Leigh Nembhard, Philadelphia, PA (US)

(21) Appl. No.: 18/958,900

(22) Filed: Nov. 25, 2024

(51) Int. Cl. G06N 5/025

(52) U.S. Cl. CPC G06N 5/025

(57) ABSTRACT

The present disclosure relates to systems, methods, and non-transitory computer-readable media for using rule-based automations that can be executed upon upload of a content item. In some embodiments, upon receiving an upload of a content item, the disclosed systems can determine an automation rule for the content item. In particular, the disclosed systems can process content item data of an uploaded content item and/or extract content item metadata associated with the content item. In some cases, the disclosed systems compare the data and/or the metadata to a set of automation rules associated with a user account. For instance, using the data and/or the metadata, the disclosed systems determine whether an automation rule satisfies a threshold rule score. If so, the disclosed systems select and execute a corresponding automation. If not, the disclosed systems can use secondary measures to select and execute a corresponding automation.

### BACKGROUND

In the field of cloud-based digital content management, recent years have seen significant developments in simplifying storage structures and offloading device functions to servers. For instance, existing storage systems have been developed with automated folders for executing a predefined function on a content item upon detecting its addition to a specific folder. In these existing systems, automated processes provide some level of improvement in offloading device functions, but existing systems nevertheless exhibit a number of deficiencies or drawbacks, particularly relating to flexibility and navigational efficiency.

As just suggested, some existing systems are inflexible. For example, while existing systems typically rely on conventional folders to organize and automate content items, reliance on the rigid folder paradigm confines automated functions to content items added to folders. Not only this, but existing automated folders frequently limit automated functions to a single function designated for a single folder. Thus, although prior systems may provide some form of automation functionality, the automation of prior systems is limited both in terms of which content items are eligible and which functions are specifically defined for automation.

Furthermore, relying on conventional folder structures to organize and automate content items is even more inflexible when dealing with multiple user accounts (e.g., a team of user accounts). In the context of collaboration, existing systems typically use shared folders for storing and sharing content among collaborating user accounts. As more user accounts interact with shared folders as part of a collaborative effort, the chance of conflicts (e.g., overwriting files or creating duplicates) increases. Additionally, as the number of collaborating user accounts expands, managing permissions for each individual user account (and their permission levels respective to each individual content item) also becomes increasingly difficult. Thus, the inflexible natures of existing systems often further result in inaccurate permission settings as well as corrupted and/or missing data from multiple conflicting versions of a content item.

Due at least in part to their inflexibilities, existing systems are also inefficient. For example, existing systems often require an excessive number of device interactions with user interfaces to perform functions and access data. Although conventional systems provide a mechanism for automating single functions on a per-folder basis, such a mechanism nevertheless requires device interactions to create the folder, set up the automated function for the folder, and then move content items to the folder before initiating an automated function. Existing systems frequently compound the number of interactions in cases where different versions of a content item are intended for different automations, requiring that the different versions be separately uploaded and separately moved to folders designated for respective automations. Consequently, not only do existing systems require excessive numbers of device interactions, but such systems also consume excessive computational resources processing such large numbers of interactions that could otherwise be preserved with a more efficient system.

These along with additional problems and issues exist with regard to conventional systems.

### BRIEF SUMMARY

This disclosure describes one or more embodiments of systems, methods, and non-transitory computer-readable storage media that provide benefits and/or solve one or more of the foregoing and other problems in the art. For instance, the disclosed systems can use rule-based automations executed upon upload of a content item to a cloud storage system. By utilizing rule-based automations executable upon upload, the disclosed systems can provide more flexibility as to how content items are stored, processed, and automated, and can also decrease the amount of device interactions required both before and after an automation has taken place.

In some embodiments, upon receiving an upload of a content item, the disclosed systems can determine an automation rule for the content item. In particular, the disclosed systems can process content item data of an uploaded content item and/or extract (e.g., before receiving the uploaded content item and/or upon receiving the uploaded content item) content item metadata associated with the content item. In some cases, the disclosed systems compare the processed data and/or the extracted metadata to a set of automation rules associated with a user account. For instance, using the processed data and/or the extracted metadata, the disclosed systems determine whether an automation rule satisfies a threshold rule score. If so, the disclosed systems select and executes a corresponding automation. If not, the disclosed systems can use secondary measures to select and execute a corresponding automation. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example overview of receiving an upload of a content item and, upon upload, determining and executing an automated operation on the content item in accordance with one or more embodiments.

FIG. 2 illustrates an example diagram of processing content item data of a content item and/or extracting content item metadata of a content item to determine rule scores in accordance with one or more embodiments.

FIG. 3 illustrates an example diagram of generating sets of automation rules in accordance with one or more embodiments.

FIG. 4 illustrates an example diagram of a process for selecting an automation rule based on determining whether an automation rule satisfies a determined rule score in accordance with one or more embodiments.

FIG. 5 illustrates an example diagram of determining a fallback automation rule based on detecting a broken automation rule in accordance with one or more embodiments.

FIG. 6 illustrates an example diagram of executing one or more processes defined by an automated operation in accordance with one or more embodiments.

FIG. 7 illustrates an example user interface for generating automation rules in accordance with one or more embodiments.

FIG. 8 illustrates an example user interface for managing automation rules in accordance with one or more embodiments.

FIG. 9 illustrates a diagram of an example environment in which an upload automation system can operate in accordance with one or more embodiments.

FIG. 10 illustrates an example flowchart of a series of acts for executing one or more processes defined by an automated operation in accordance with one or more embodiments.

FIG. 11 illustrates a block diagram of an exemplary computing device in accordance with one or more embodiments.

FIG. 12 illustrates an example environment of a networking system including the upload automation system in accordance with one or more embodiments.

### DETAILED DESCRIPTION

This disclosure describes one or more embodiments of an upload automation system 100 that can uniquely utilize rule-based automations that are executable upon upload of a content item to a cloud storage system. In some embodiments, the upload automation system 100 receives an upload of a content item at a cloud-based content management system and, in response to receiving the upload, determines an automation rule associated with the content item. To determine the automation rule, the upload automation system 100 can compare content item data and/or content item metadata to a set of automation rules associated with a user account initiating the upload (or associated with the upload directory). In some instances, from the automation rule, the upload automation system 100 determines an automated operation to execute on the content item and execute one or more processes defined by the automated operation.

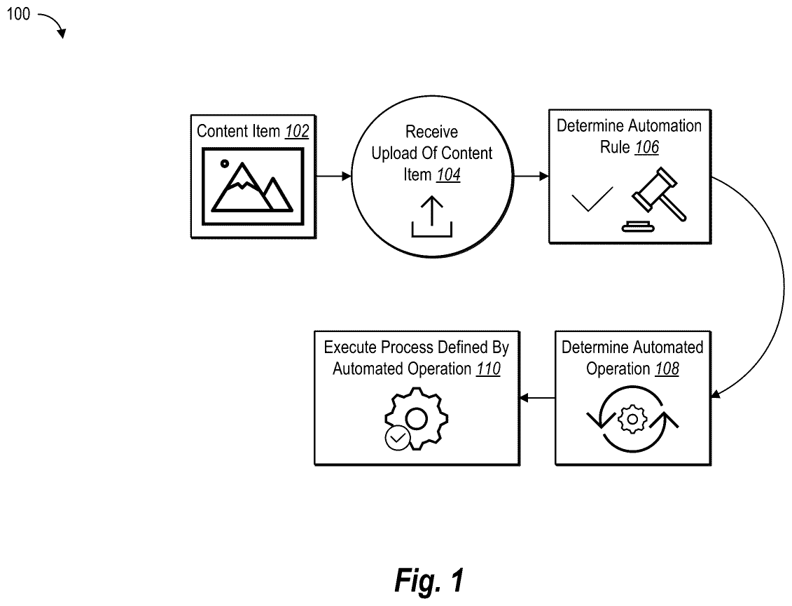

Additional detail regarding the upload automation system will now be provided with reference to the figures. For example, FIG. 1 illustrates an example overview of receiving an upload of a content item and, upon upload, determining and executing an automated operation on the content item in accordance with one or more embodiments. Additional detail regarding the various acts and processes introduced in relation to FIG. 1 is provided thereafter with reference to subsequent figures.

As illustrated in FIG. 1, the upload automation system 100 processes a content item 102 (or multiple content items) for a user account at a content management system. Specifically, the upload automation system 100 performs an act 104 to receive an upload of the content item 102. In particular, upon performing the act 104 (or upon detecting the upload), the upload automation system 100 can process the content item data of the content item 102. In some cases, the upload automation system 100 processes the content item 102, including its internal content and/or its metadata, based on predicting an upload and/or predicting that an upload will occur within a threshold time period (e.g., 10 seconds, 1 hour, or 1 day). The upload automation system 100 can thus prepare the content item 102 for an automated operation upon performing the act 104.

In some instance, when processing the content item data, the upload automation system 100 can perform an analysis on the internal content of the content item 102 (e.g., by using a large language learning model (LLM)). Additionally or alternatively, upon performing the act 104, the upload automation system 100 can extract content item metadata associated with the content item 102. In additional or alternative embodiments, the upload automation system 100 extracts the content item metadata associated with the content item 102 prior to performing the act 104.

As further illustrated in FIG. 1, the upload automation system 100 performs an act 106 to determine an automation rule associated with the content item 102. Specifically, the upload automation system 100 can determine a set of automation rules associated with the user account. In some cases, to perform the act 106, the upload automation system 100 compares the processed content item data and/or the extracted content item metadata to the set of automation rules associated with the user account. For example, the upload automation system 100 compares user accounts, topics, and/or other data associated with the content item 102 with those associated with various automation rules.

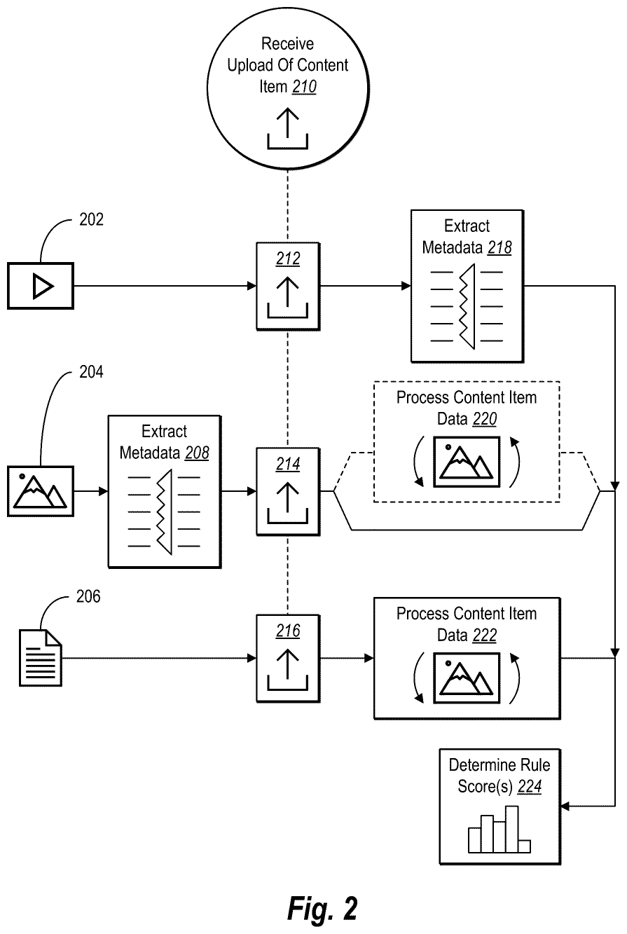

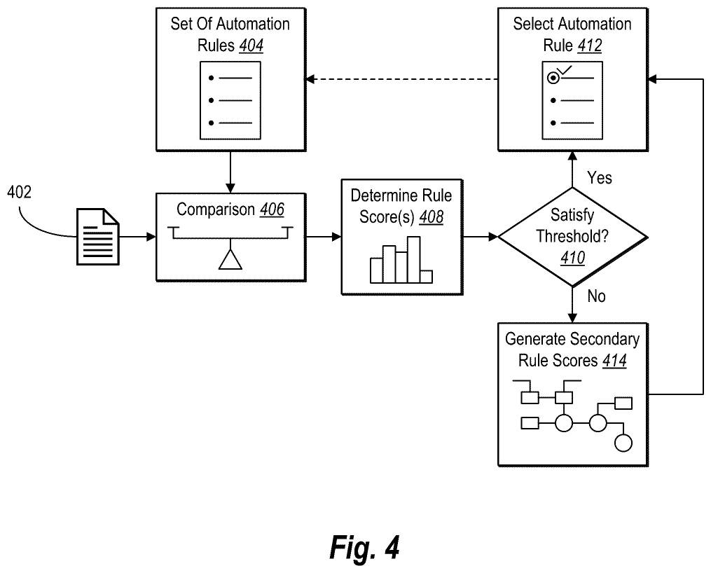

Based on the comparison of the processed content item data and/or the extracted content item metadata to the set of automation rules, the upload automation system 100 determines rule scores indicating how related automation rules are to the content item 102. In some instances, the upload automation system 100 determines whether an automation rule in the set of automation rules satisfies a threshold rule score. If so, the upload automation system 100 can select the automation rule for the content item 102. If not, the upload automation system 100 can use secondary measures, including one or more machine learning models to process the content item 102 and/or various automation rules, to generate secondary rule scores for automation rules in the set of automation rules. In some embodiments, upon determining that an automation rule satisfies a threshold secondary rule score, the upload automation system 100 performs the act 106 by selecting the automation rule for the content item 102. See FIGS. 2 and 4 below for additional details regarding this process.

As shown in FIG. 1, from the determined automation rule, the upload automation system 100 performs an act 108 to determine an automated operation to execute on the content item 102. In particular, the upload automation system 100 can determine one or more operations involved in the automation rule to perform the act 108. For instance, the upload automation system 100 determines that a determined (or selected) automation rule includes a first automated operation to, upon detecting upload, move the content item 102 from a first directory to a second directory within the content management system. The upload automation system 100 can further determine that the determined automation rule includes a second automated operation to, upon detecting movement to the second directory, rename the content item 102.

In some embodiments, as part of determining the automation rule, the upload automation system 100 can use the processed content item data and/or the extracted content item metadata to determine or predict one or more purposes or intents for uploading the content item 102 (e.g., to modify in a specific way or to send to a specific user). For instance, the upload automation system 100 can predict a purpose/intent to send a content item to a particular user account and/or to modify the content item in a particular fashion. Based on a determined purpose, the upload automation system 100 can determine and select an automated operation that will execute one or more processes that will satisfy the purpose (e.g., by modifying in the specific way or sending to the specific user). In the same or other embodiments, the upload automation system 100 can also perform the act 108 based on other factors, including detecting a trigger event that matches specific criteria and/or using conditional logic to detect and handle a condition that matches specific criteria.

As also shown in FIG. 1, the upload automation system 100 performs an act 110 to execute one or more processes defined by an automated operation. For instance, the upload automation system 100 can execute one or more processes that include, but are not limited to, moving the content item 102, sharing the content item 102, transforming and/or modifying the content item 102, and/or setting permissions for the content item 102. In the same or other embodiments, the upload automation system 100 can also execute an operation to perform a negative action on the content item 102 (e.g., not performing action to prevent a certain other action or result from occurring) and/or to integrate the content item 102 with a software connector.

In one or more embodiments, the upload automation system 100 can provide several improvements or advantages over existing systems. For instance, the upload automation system 100 can improve flexibility over prior systems. While they may be able to automate functions to some extent, prior systems typically confine automations to single functions executed on content items added to individual folders. By contrast, the upload automation system 100 improves flexibility by introducing the concept of automating functions for a content item upon upload of the content item to a content management system (e.g., before assigning to a folder or directory). Consequently, in some embodiments, the upload automation system 100 is not limited to folder-based automations of a single function for a single folder but can instead flexibly adapt different content items to different automated functions on a per-content-item basis.

Additionally, the upload automation system 100 further improves flexibility over prior systems in the collaborative context. In contrast with prior systems that rely on (or mandate) using shared folders for collaborative content, the upload automation system 100 does not require (although it may permit) using shared folders, even when dealing with multiple user accounts (e.g., a team of user accounts). For example, upon upload of a content item, the upload automation system 100 can determine that a content item is to be shared with multiple collaborating user accounts and can automatically distribute the content item (or otherwise make a centrally shared version of the content item available) to the collaborating user accounts upon upload (and can do so without requiring that the content item first be placed into a shared folder). Because the upload automation system 100 does not require using shared folders and instead automates the designation of and access to collaborative content items, it can decrease the chance of conflicts (e.g., overwriting files or creating duplicates) frequently seen in prior systems that utilize shared folders. Indeed, the upload automation system 100 can automatically detect uploads of content changes to shared content items and can propagate the changes to collaborating user accounts upon upload.

Along these lines, the upload automation system 100 more flexibly manages permissions of user accounts. In particular, while prior systems implement cumbersome mechanisms for managing permissions on a per-account basis (which is only magnified as the number of collaborating user accounts expands), the upload automation system 100 more flexibly (and automatically) updates and manages user account permissions. Indeed, in some embodiments, the upload automation system 100 circumvents the burden of individually setting user account (and their permission levels respective to each individual content item) by automating the process of setting permissions for user accounts (and for content items). For example, the upload automation system 100 automates sharing (or moving) multiple versions of a content item to particular user accounts based on determining permissions of the accounts and the content item (e.g., upon upload and without requiring placing the multiple versions into a shared folder and managing permissions).

In addition to improving flexibility, embodiments of the upload automation system 100 also improve navigational efficiency. For instance, the upload automation system 100 decreases the number of device interactions with user interfaces to perform functions and access data. To elaborate, many existing systems require device interactions to create a folder, set up an automated function for the folder, and then move content items to the folder before initiating an automated function. The upload automation system 100, on the other hand, introduces automation functions for content items upon their upload. By utilizing this approach, embodiments of the upload automation system 100 initiate an automation function without requiring—or greatly reducing the number of—device interactions often required by existing systems. Moreover, also unlike conventional systems that require separately uploading different versions of a content item and separately moving the different versions to folders designated for respective automations, the upload automation system 100 only requires receiving an upload of a single content item. For example, upon receiving an upload of a single content item, the upload automation system 100 can generate different versions of the content item and perform respective automation functions on each version (e.g., to move each version to a respective destination folder or respective user accounts). In consequence of the above, by processing far lesser numbers of interactions, embodiments of the upload automation system 100 require less processing power and, therefore, perform operations with improved efficiency over prior systems.

As illustrated by the foregoing discussion, the present disclosure utilizes a variety of terms to describe features and advantages of the video transcript segmentation system. Additional detail is now provided regarding the meaning of such terms. As used herein, the term “automation rule” (or “upload automation rule”) refers to predefined conditions, triggers, logic, and/or actions that can govern the execution of computer processes (or operations) automatically (e.g., without intervention from user interactions) within a system. In some cases, an automation rule is designed to streamline repetitive operations, enforce standard procedures, and/or to enhance operational efficiency by minimizing the need for manual intervention. An automation rule can consist of several key components. For instance, the upload automation system 100 can define an automation rule as initiated by a trigger event (e.g., according to specific events or conditions) and including one or more automated operations executed in response to the trigger event. As an example, an automation rule may incorporate conditions, which act as logical checks that must be satisfied for the automation rule to proceed. These conditions can filter or validate whether the rule should execute based on criteria, such as specific scores, values, states, or thresholds. Once triggered and/or conditions are met, the automation rule can execute one or more automated operations.

Relatedly, as used herein, the term “automated operation” refers to one or more processes (or tasks or functions) that can be executed automatically by a system or software without human intervention. In particular, an automated operation can include a discrete function executable by a particular application or subroutine, where the operation is made up of computer processes. An automated operation can be initiated, for example, by various trigger events as part of an automation rule (where the automation rule may include multiple automated operations, each triggered by its own trigger event). Once initiated, the automated operation follows a series of predefined programmed steps. The programmed steps may include conditional logic to handle different scenarios, ensuring that the automated operation can adapt to varying inputs or situations. Furthermore, in one or more embodiments, automated operations can be designed to work seamlessly across multiple systems or platforms, utilizing application programming interfaces (APIs), webhooks, or other integration methods to coordinate actions.

On those same lines, as used herein, the term “trigger event” refers to a specific occurrence or condition that initiates the execution of a predefined process (or action) within the upload automation system 100. In particular, a trigger event can serve as a catalyst that activates automation rules (and/or automated operations), allowing tasks to be performed without manual intervention. A trigger event can take various forms, including but not limited to, a scheduled time-based event (e.g., a task set to run at a particular time or interval), a system event (e.g., the creation, modification, or deletion of a file or record), a data-driven event (e.g., a change in the status of a database field), and/or an external signal (e.g., a device interaction or a webhook or API call from another system). Upon detecting the trigger event, the upload automation system 100 can evaluate any associated conditions, and if these conditions are met, the upload automation system 100 can proceed to execute the specified processes.

As also used herein, the term “upload” refers to a process of transferring files, data, and/or other content items from a local device or system (e.g., a computer or mobile device) or from cloud storage to a remote system, server, platform, and/or cloud storage (e.g., via a network connection). Uploading can involve the use of communication protocols such as HTTP, HTTPS, FTP, or SFTP, and can include various types of data, such as documents, images, videos, or raw datasets. Upon upload, a content item may be stored in destination storage infrastructure, such as an upload directory, a file system, a database, and/or a cloud storage. However, the upload automation system 100 does not require that a content item be uploaded (or moved) to a particular destination (e.g., a folder) before it will initiate an automated function. Indeed, the upload automation system 100 can determine an automated operation executable on the content item based on the upload of the content item to the content management system irrespective of the location (e.g., folder) to which the content item was uploaded.

As used herein, the term “content item” can refer to a digital object or a digital file that includes information interpretable by a computing device (e.g., a client device) to present information to a user. A content item can include a file or a folder such as a digital text file, a digital image file, a digital audio file, a webpage, a website, a digital video file, a web file, a link, a digital document file, or some other type of file or digital object. A content item can have a particular file type or file format, which may differ for different types of content items (e.g., digital documents, digital images, digital videos, or digital audio files). In some cases, a content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A content item can be editable or otherwise modifiable and can also be sharable from one user account (or client device) to another. In some cases, a content item is modifiable by multiple user accounts (or client devices) simultaneously and/or at different times.

Relatedly, as used herein, the term “content item data” refers to facts, figures, pixels, and/or symbols that represent information defining the internal contents of a content item. In particular, content item data can include various attributes that describe, categorize, and/or define the content item, enabling the system to manage, retrieve, and/or display the content item effectively. For instance, content item data can include all the information that makes up or is related to the content item and can include the internal content of the content item itself and/or various descriptive attributes. To elaborate, if the content item is a text document, the content item data can include visible elements such as its title, body text, images, and/or other visible embedded elements.

Along those lines, as used herein, the term “content item metadata” refers to contextual information about a content item. In particular, content item metadata is distinct from content item data in that content item metadata can include data that may not directly reflect visible internal contents of a content item but may instead define information relating to, or informing the context of, the internal contents. For instance, content item metadata can include content item's creation date, file type, geotag, filename, keywords, file size, status (e.g., published, draft, or archived), permissions (e.g., access level or ownership), and/or version number. Content item metadata can also include specific data attributes associated with a particular type of content item, such as resolution and duration of a video, dimensions and format of an image, or word count and language of a text document. Additionally, in some embodiments, content item metadata encompasses data attributes such as a device identification (ID) of a device that uploaded a content item, a device ID of a device that created a content item, which user account created a content item, and/or settings (e.g., camera settings, such as aperture and zoom) that were applied when creating a content item.

Additionally, as used herein, the term “rule score” (or “threshold rule score”) refers to a quantitative measure that determines the conditions under which an automation rule will be selected and executed. In particular, a rule score can be a defined numerical value or metric that the upload automation system 100 assigns to an automation rule to indicate the relevance of a specific automation rule in relation to a content item. For example, when the upload automation system 100 generates a rule score, it determines how well the rule aligns with or is relevant to the characteristics or requirements of the content item. In some embodiments, the rule score functions as a comparative metric, evaluated against a predefined threshold that serves as a benchmark. The threshold can therefore represent the minimum score required for the rule to be considered applicable or effective for the content item. As also used herein, the term “secondary rule score” refers to a numerical value or limit that determines the conditions under which an automation rule will be selected and executed based on the upload automation system 100 determining that no automation rule satisfies a rule score. Specifically, upon determining that no automation rule satisfies a rule score, the upload automation system 100 can utilize a machine learning model to generate secondary rule scores for a set of automation rules. For instance, the upload automation system 100 can generate the secondary rule scores by utilizing the machine learning model to access knowledge graphs, organizational charts, and/or usage histories. Based on the secondary rule scores, the upload automation system 100 can select an automation rule associated with the content item to execute.

As further used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the video transcript segmentation system utilizes a large language machine learning model in the form of a neural network.

Along those lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., rule scores or secondary rule scores) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network a convolutional neural network, a recurrent neural network (e.g., an LSTM), a graph neural network, a large language model, or a generative neural network.

Further along those lines, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

As used herein, the term “knowledge graph” refers to a graph of a content management system that can store and encode relationship information to define relationships associated with a user account. In particular, the upload automation system 100 can generate and/or utilize a knowledge graph for a user account to define the relationships associated with the user account, including relationships with content items, teams (or groups), organizations, and/or other user accounts. In one or more embodiments, a knowledge graph can be system-wide and can include a node for the user account and nodes for content items and/or nodes for the other user accounts within an entirety of the content management system and/or for a particular organizational ontology (e.g., a company or a team of collaborating user accounts). Indeed, the upload automation system 100 can generate and/or utilize multiple knowledge graphs, including one that is specific to the user account and one that is system-wide (or organization-wide). In the same or other embodiments, a knowledge graph can use edges to represent relationships between the nodes (e.g., where shorter distances represent stronger relationships than longer distances).

Further, as used herein, the term “software connector” (or more simply “connector”) refers to a computer code segment, application, or program that retrieves or extracts data and/or features that define information from user-account-facing applications, such as digital calendars, video call applications, email applications, text messaging applications, digital document applications, and other applications. In some cases, a connector is as described by Vasanth Krishna Namasivayam et al. in U.S. patent application Ser. No. 18/478,061 and Ser. No. 18/478,066, titled GENERATING AND MAINTAINING COMPOSITE ACTIONS UTILIZING LARGE LANGUAGE MODELS, filed Sep. 29, 2023, both of which is incorporated herein by reference in their entireties. In one or more implementations, a connector is as described by Aniruddh Rao et al. in U.S. patent application Ser. No. 18/776,830, titled DATA INGESTION UTILIZING A COORDINATOR AND CONNECTORS, filed Jul. 18, 2024. A software connector can use web hooks, long polling, another protocol to ingest content from, and provide instructions to, an external source into the environment of a content management system for interaction with content management system functions, including those of the unified search system.

Additional detail regarding the upload automation system 100 will again be provided with reference to the figures. For example, as mentioned above, the upload automation system 100 can receive an upload of a content item. In particular, the upload automation system 100 can process content item data of an uploaded content item and/or extract (e.g., before receiving the uploaded content item and/or upon receiving the uploaded content item) content item metadata associated with the content item. FIG. 2 illustrates an example diagram of processing content item data of a content item and/or extracting content item metadata of a content item to determine rule scores in accordance with one or more embodiments.

As illustrated in FIG. 2, the upload automation system 100 receives an upload of a content item (e.g., content item 202, content item 204, and/or content item 206). In particular, the upload automation system 100 can perform an act 210 (e.g., act 212, act 214, and/or act 216 for respective content items) to receive an upload of one or more content items. For example, the upload automation system 100 can perform the act 210 by utilizing software connectors. To elaborate, in one or more embodiments, the upload automation system 100 can identify the one or more content items stored in various network locations or servers of a content management system (e.g., associated with one or more user accounts) by associating the content management system with the one or more content items via the software connectors. In some cases, the upload automation system 100 can associate the one or more content items with the content management system by using the software connectors to link, ingest, and/or pull the one or more content items stored at external network locations to the content management system. This is done, for instance, to upload the connector-linked one or more content items to the content management system (and/or the upload automation system 100) and render them searchable, analyzable, and/or manipulable using functions of the content management system (and/or of the upload automation system 100).

In the same or other embodiments, the upload automation system 100 can perform the act 210 in a number of additional or other ways. For instance, the upload automation system 100 can perform the act 210 by, for example, utilizing a direct file upload via a web interface (e.g., receiving a file uploaded from a device, such as via a web page form), a file transfer protocol (FTP), an application programming interface (API), a drag-and-drop interface, syncing with a cloud storage (e.g., syncing folders between devices), an application upload (e.g., a mobile application upload via in-app option to upload content), an email attachment, and/or a command-line tool or shell access.

As also illustrated in FIG. 2, upon performing the act 210 (or upon detecting the upload), the upload automation system 100 can process the content item data of a content item (e.g., while the content item is in temporary storage or cached in device memory). For example, upon performing the act 212 to receive the upload of the content item 202 (or upon detecting the upload of the content item 202), the upload automation system 100 performs an act 218 to extract and/or process content item metadata associated with the content item 202. In some embodiments, the upload automation system 100 can integrate the content item 202 with a software connector to retrieve or extract the content item metadata.

In some embodiments, the upload automation system 100 processes the content item 204, including its internal content and/or its metadata, based on predicting an upload and/or predicting that an impending upload will occur within a threshold time period (e.g., 10 seconds, 1 hour, or 1 day). For instance, based on one or more previous content item uploads, the upload automation system 100 can predict the upload of content item 204 and/or predict that the content item 204 will be uploaded within the threshold time period. In one or more embodiments, based on predicting an upload and/or predicting that an upload will occur, the upload automation system 100 receives (and/or requests) an upload of the content item metadata associated with the content item 204 prior to performing the act 214 (or prior to detecting the upload).

In some instances, upon receiving the upload of the content item metadata, the upload automation system 100 performs an act 208 to extract and/or process the content item metadata associated with content item 204. The upload automation system 100 can thus, in some embodiments, prepare the content item 204 for an automated operation upon receiving the upload of the content item 204. In the same or additional embodiments, the upload automation system 100 can integrate the content item 204 with a software connector to retrieve or extract the content item metadata.

In the same or other embodiments, upon performing the act 208 and the act 214 (or upon detecting the upload), the upload automation system 100 can optionally perform the act 220 to process content item data (e.g., internal content) of the content item 204. In particular, the upload automation system 100 can process the content item data by performing an analysis on (e.g., by scanning and/or via visual intelligence) the internal content of the content item 102. In some embodiments, the upload automation system 100 uses a machine learning model (e.g., a large language model (LLM)) to perform the analysis. Specifically, the upload automation system 100 can use the machine learning model (e.g., the LLM) to summarize the internal content of the content item 204 and extract topics or themes therefrom. The upload automation system 100 can additionally or alternatively integrate the content item 204 with a software connector to retrieve and/or process the content item content item data. In at least one embodiment, performing the analysis on (e.g., by scanning) the internal content of the content item is based on a permission that enables the function. As an example, the upload automation system 100 provides, in a graphical user interface of a client device, a selectable element that can be selected to provide permission to analyze (or scan) the internal content of the content item 204.

As further illustrated in FIG. 2, the upload automation system 100 performs the act 222 to process content item data of the content item 206 upon performing the act 216 (or upon detecting the upload). In some cases, the upload automation system 100 can perform the act 222 without extracting content item metadata associated with content item 206 prior to performing the act 216 (or prior to detecting the upload). In one more embodiments, the upload automation system 100 processes the content item data by performing an analysis on the internal content of the content item 102 according to the manner outlined above in relation to the content item 204.

As shown in FIG. 2, the upload automation system 100 performs the act 224 to determine rule scores for automation rules in a set of automation rules. Specifically, the upload automation system 100 compares processed content item data and/or extracted content item metadata to the set of automation rules. Based on the comparison, the upload automation system 100 performs the act 224 based on how closely related the automation rules are to the content items (e.g., the content items 202, 204, and/or 206). See FIG. 4 below for additional details regarding this process.

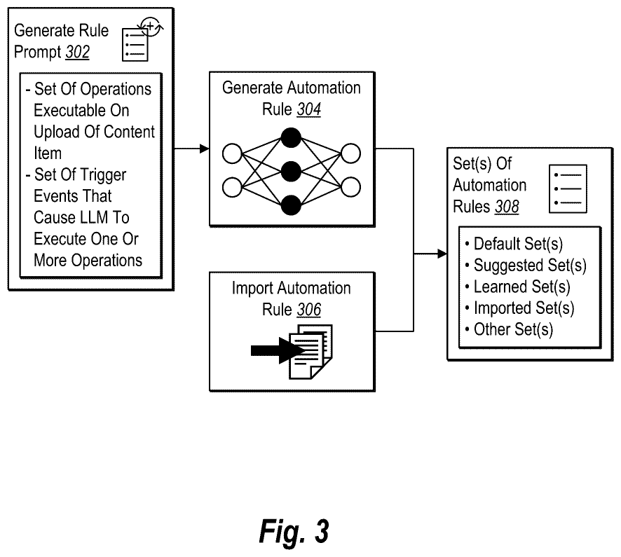

As expressed above, in some embodiments, the upload automation system 100 determines a set of automation rules associated with a user account. Specifically, the upload automation system 100 can generate and/or import a number of sets by associating (or combining) automation rules. FIG. 3 illustrates an example diagram of generating sets of automation rules in accordance with one or more embodiments.

As illustrated in FIG. 3, the upload automation system 100 performs an act 302 to generate a rule prompt. In particular, the upload automation system 100 can generate a rule prompt that includes a description of a set of operations that can be executed upon upload of the content item. In the same or other embodiments, the upload automation system 100 generates a rule prompt that includes a description of a set of trigger events that, upon detection, cause the machine learning model (e.g., the LLM) to execute one or more operations among a set of operations.

As also illustrated in FIG. 3, upon performing the act 302, the upload automation system 100 performs an act 304 to generate one or more automation rules. In particular, the upload automation system 100 can perform the act 304 by utilizing a machine learning model (e.g., an LLM) to interpret the generated rule prompt. For instance, the upload automation system 100 interprets the intent and parameters specified in the generated rule prompt and translates (or converts) the generated rule prompt into an executable automation rule.

In some embodiments, the upload automation system 100 generates one or more of various types of automation rules. For example, the upload automation system 100 can generate a default automation rule that is associated with user accounts across a content management system. In some cases, the upload automation system 100 can generate the default automation rule based on a predefined template associated with one or more user accounts across the content management system. Indeed, the upload automation system 100 can determine common baseline operations to include in a default set, such as moving a content item to a designated folder and/or sending a content item to a designated user account.

As another example, the upload automation system 100 can generate a suggested automation rule for a user account based on historical interactions by the user account (and/or user accounts within a threshold similarity of the user account, as indicated by a knowledge graph) with content items within the content management system. In some instances, the upload automation system 100 can generate the suggested automation rule based on common patterns and/or best practices that align with a user account's environment and/or the user account's historical activity. In one or more embodiments, the upload automation system 100 can generate the suggested automation rule by using a heuristic model and/or similar (or associated) users account preferences.

In the same or additional embodiments, the upload automation system 100 generates a learned automation rule. In particular, the upload automation system 100 can generate the learned automation rule based on detecting a specific user account's repetitive actions and/or behavior patterns over a period of time. In some embodiments, the upload automation system 100 can generate the learned automation rule using a machine learning model trained on the user account's activity. To illustrate, the upload automation system 100 may use the machine learning model to analyze historical data and user interactions to identify patterns and refine the learned automation rule based on feedback.

In yet another example, the upload automation system 100 generates a new automation rule. In particular, in some embodiments, the upload automation system 100 provides a mechanism for generating one or more new automation rules (e.g., a custom automation rule). For instance, the upload automation system 100 provides mechanisms to customize and/or determine the parameters of the rule prompt used for performing the act 304.

As additionally illustrated in FIG. 3, the upload automation system 100 performs an act 306 to import an automation rule. Specifically, the upload automation system 100 may import the automation rule from a team (or an organization) associated with a user account. In the same or other embodiments, the upload automation system 100 may import the automation rule from an alternative user account (e.g., associated with the content management system). In some instances, the upload automation system 100 can import a default automation rule (e.g., based on a predefined template) associated with the team (or the organization) and/or one or more alternative user accounts across the content management system. The upload automation system 100 may also import a suggested automation rule, a learned automation rule, and/or a new automation rule (e.g., generated via mechanisms for a user account to customize and/or determine the parameters of the rule prompt used for performing the act 304) associated with the team (or organization) and/or the one or more alternative user account.

In at least one embodiment, the upload automation system 100 includes an element of retroactivity. In particular, the upload automation system 100 may provide, for display in a graphical user interface of a client device, one or more selectable elements to retroactively apply automated operations to content items based on automation rules generated and/or imported via the act 304 and/or the act 306. For instance, the upload automation system 100 can generate an automation rule and/or import an automation rule that will only affect one or more currently uploading content items, one or more future uploaded content items, and/or one or more previously uploaded content items.

As further illustrated in FIG. 3, the upload automation system 100 performs the act 308 to generate and/or import one or more sets of automation rules. For example, the upload automation system 100 can perform the act 308 by generating and/or importing multiple automation rules and associating (or combining) them together into a set of automation rules. In some embodiments, the upload automation system 100 generates and/or imports a default set of automation rules that includes a plurality of default automation rules. The upload automation system 100 may, in some cases, generate and/or import a suggested set of automation rules that includes a plurality of suggested automation rules. In the same or other embodiments, the upload automation system 100 generates and/or imports a learned set of automation rules that includes a plurality of learned automation rules. The upload automation system 100 can additionally or alternatively import a set of automation rules that includes imported automation rules (e.g., without the upload automation system 100 generating any automation rules for the user account).

Additionally or alternatively, the upload automation system 100 can generate and/or import another set of automation rules. As an example, the other set of automation rules can include a plurality of the new automation rules that were generated via mechanisms for a user account to customize and/or determine the parameters of the rule prompt used for performing the act 304. As another example, the other set of automation rules can include an association (or combination) of various types of automation rules. Indeed, the upload automation system 100 may associate (or combine) one or more default automation rules, one or more suggested automation rules, one or more learned automation rules, one or more imported automation rules, and/or one or more new automation rules.

In some embodiments, the upload automation system 100 provides, for display in a graphical user interface of a client device, one or more mechanisms or elements for updating or modifying an automation rule (and/or a set of automation rules). For example, the upload automation system 100 updates or modifies the automation rule (and/or the set of automation rules) based on detecting a user interaction a rule modification element that provides options to change rule parameters, such as automated operations and/or trigger events associated with the automation rule.

In the same or other embodiments, the upload automation system 100 can import (and/or incorporate) automation rules by integrating with a machine learning model (e.g., an LLM). In particular, a machine learning model can be trained to automatically generate an automation rule for the upload automation system 100. In some embodiments, the upload automation system 100 integrates with the machine learning model and imports (and/or incorporates) the automation rules generated by the machine learning model. Thus, in some cases, the automation rules are dynamically generated and incorporated based on integrating the machine learning model.

As mentioned above, the upload automation system 100 can determine an automation rule associated with a content item. Specifically, the upload automation system 100 can determine a set of automation rules associated with a user account. FIG. 4 illustrates an example diagram of a process for selecting an automation rule based on determining whether an automation rule satisfies a determined rule score in accordance with one or more embodiments.

As illustrated in FIG. 4, the upload automation system 100 performs an act 406 to compare processed content item data of content item 402 and/or extracted content item metadata associated with content item 402 to a set of automation rules 404 associated with a user account. In particular, the upload automation system 100 can process content item data of the content item 402 and/or extract content item metadata from the content item 402, as described above. In the same or other embodiments, the upload automation system 100 generates and/or imports the set of automation rules 404 by associating (or combining) a plurality of automation rules, as also described above.

Upon processing the content item data and/or extracting the content item metadata and upon generating and/or importing the set of automation rules 404, the upload automation system 100 can perform the act 406. In particular, the upload automation system 100 can evaluate how closely the processed content item data and/or the extracted content item metadata matches conditions of one or more automation rules in the set of automation rules 404. For example, the upload automation system 100 compares user accounts, topics, and/or other data associated with the content item 402 with those associated with various automation rules within the set of automation rules 404.

In the same or other embodiments, the upload automation system 100 can utilize secondary parameters to improve the confidence score. In particular, the upload automation system 100 can augment the comparison process by using the secondary parameters (e.g., filtering tools) to select automation rules that can be eligible for comparison. As an example, a secondary parameter could require that an automation rule be created between two given years (e.g., 2018 and 2019) to be eligible for comparison when performing the act 406. If that secondary parameter was selected and/or otherwise utilized, the upload automation system 100 can filter through the automation rules in the set of automation rules 404 to only permit automation rules created between the two given years (e.g., 2018 and 2019) to be used in performing the act 406.

As also illustrated in FIG. 4, based on performing the act 406, the upload automation system 100 performs an act 408 to determine rule scores for the set of automation rules 404. In particular, the upload automation system 100 performs the act 408 to determine rule scores indicating how related the automation rules in the set of automation rules 404 are to the content item 402. For instance, the upload automation system 100 can use a machine learning model (e.g., a large language model (LLM)) to perform the act 408. To elaborate, the upload automation system 100 can use the machine learning model to extract an embedding from each automation rule in the set of automation rules 404 and from the content item 402. Upon extracting the embeddings, the upload automation system 100 can use the machine learning model to determine a similarity score for each automation rule (e.g., a cosine similarity or a distance in the embedding space between embeddings, such as between an automation rule embedding and the content item 402 embedding) by comparing each automation rule embedding with the content item 402 embedding. In some instances, based on determining a similarity score for each automation rule, the upload automation system 100 selects an automation rule with the highest score (e.g., the closest distance in the embedding space between embeddings), so long as the automation rule also satisfies a threshold.

As further illustrated in FIG. 4, the upload automation system 100 performs the act 410 to determine if an automation rule satisfies a threshold (or a threshold rule score). In particular, upon performing the act 408, the upload automation system 100 can perform the act 410 by comparing a rule score for an automation rule to a threshold. In some cases, if the rule score meets or exceeds the threshold, the upload automation system 100 determines that the automation rule has satisfied the threshold (e.g., is sufficiently relevant). In one or more embodiments, the upload automation system 100 uses dynamic or adaptive thresholds (e.g., percentage thresholds and/or range-based thresholds) to perform the act 410. In the same or other embodiments, the upload automation system 100 can determine the threshold via one or more methods. For instance, the upload automation system 100 can determine the threshold based on a pre-determined value, historical data analysis, machine learning, statistical methods, A/B testing and experimentation, and/or feedback loops and adjustments.

As shown in FIG. 4, the upload automation system 100 performs the act 412 to select an automation rule. In particular, in at least one embodiment, the upload automation system 100 performs the act 412 upon determining that a rule score satisfies a threshold.

As also shown in FIG. 4, in some embodiments, the upload automation system 100 performs the act 412 by using secondary measures based on determining that initial rule scores did not satisfy the threshold rule score. In particular, upon determining that no automation rule satisfies a threshold, the upload automation system 100 performs an act 414 to generate one or more secondary rule scores. In some embodiments, the upload automation system 100 utilizes a machine learning model to perform the act 414 for the set of automation rules 404. For instance, the upload automation system 100 performs the act 414 by utilizing the machine learning model to access knowledge graphs, organizational charts, and/or usage histories (e.g., of a user account and/or a team (or an organization) associated with the user account). To elaborate, the upload automation system 100 can access and process data from the knowledge graphs, organizational charts, and/or usage histories to determine relationships between the content item and the automation rules. For example, the upload automation system 100 accesses and processes data from a knowledge graph to monitor and/or observe how relationships between user accounts and content items, teams (or groups), organizations, and/or other user accounts change over time. To elaborate, the upload automation system 100 can determine, based on monitoring and/or observing relationships over time, the strength of a relationship and the probability that a content item will require an automation.

As mentioned above, to perform the act 414, the upload automation system 100 can access and process data from an organization chart. In some embodiments, an organizational chart can refer to a hierarchal stratification of user accounts within a team (or group) and/or an organization. In the same or other embodiments, based on accessing and processing data from an organization chart, the upload automation system 100 can perform the act 414 by determining the strength of a relationship between a user account and content items, teams (or groups), organizations, and/or other user accounts. Further, in some cases, by determining the strength of the relationship, the upload automation system 100 determines a probability that a content item will require an automation. As an example, the upload automation system 100 can determine that User Account A and User Account B are both at the same hierarchal level in an organization and that both user accounts are working on Project X. Based on these determinations, the upload automation system 100 can determine that the User Account A and the User Account B have a stronger relationship to each other and with the Project X, and that there is a higher probability that a content item related to Project X should be shared with both the User Account A and the User Account B.

As also mentioned above, to perform the act 414, the upload automation system 100 can access and process data from a usage history. In some embodiments, a usage history can refer to steps or actions taken by a user account upon one or more previously uploaded content items associated with a particular project, folder, content item, user account, team (or group), and/or organization. In the same or other embodiments, based on accessing and processing data from a usage history, the upload automation system 100 can perform the act 414 by determining the strength of the relationship between a content item and the one or more previously uploaded content items. Further, in some cases, by determining the strength of the relationship, the upload automation system 100 determines a probability that steps or actions previously taken by a user account upon the one or more previously uploaded content items should be performed on the content item.

In one or more embodiments, the upload automation system 100 performs the act 414 based on one or more of the above determinations made upon processing a knowledge graph, an organizational chart, and/or a usage history. In particular, the upload automation system 100 can determine that stronger relationships and/or higher probabilities can correlate with a higher secondary rule score. In some cases, the upload automation system 100 can combine some or all of the information obtained from processing the knowledge graph, organizational chart, and/or usage history to perform the act 414 (e.g., by producing a weighted combination secondary rule score). In the same or other embodiments, the upload automation system 100 performs the act 412 by determining that an automation rule satisfies a threshold secondary rule score (by a process similar to what is described above in relation to performing the act 410).

In at least one embodiment, accessing the knowledge graphs, organizational charts, and/or usage histories is based on a permission that enables the function. As an example, the upload automation system 100 provides, in a graphical user interface of a client device, a selectable element that can be selected to provide permission to access the knowledge graph, organizational charts, and/or usage histories.

In some embodiments, the upload automation system 100 determines one or more automation rules for the content item 402 from a selected automation rule (or selected automation rules). In particular, upon performing the act 412, the upload automation system 100 may repeat the processes explained above in relation to FIG. 4 to select another automation rule. For example, the upload automation system 100 repeats the processes explained above in relation to FIG. 4 for a plurality of automation rules and/or for all the automation rules in the set of automation rules 404. In some embodiments, the upload automation system 100 determines one or more automation rules for the content item 402 based on determining that the one or more automation rules have a particular rule score (and/or secondary rule score). Indeed, the upload automation system 100 can determine a particular automation rule for the content item 402 based on determining that the particular automation rule has the highest rule score (or the highest secondary rule score).

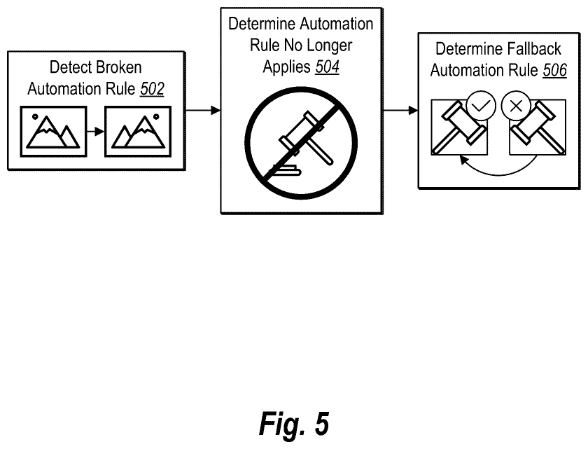

As mentioned above, the upload automation system 100 can determine an automation rule for a content item. In particular, the upload automation system 100 can determine the automation rule by comparing processed content item data and/or extracted content item metadata to a set of automation rules associated with the user account. FIG. 5 illustrates an example diagram of determining a fallback automation rule based on detecting a broken automation rule in accordance with one or more embodiments.

As illustrated in FIG. 5, the upload automation system 100 performs an act 502 to detect a broken automation rule. Specifically, upon determining an automation rule for a content item, the upload automation system 100 routinely analyzes content item data of a content item and/or content item metadata associated with the content item and compares the content item data and/or content item metadata against the determined automation rule. In some embodiments, the upload automation system 100 can perform the act 502 by tracking specific conditions (or criteria), trigger events, and/or expected actions and detecting (or flagging) when they do or do not occur. For instance, if the content item data and/or content item metadata does not match the defined conditions (or criteria) of the automation rule, the upload automation system 100 will detect that the rule is broken. As an example, an automation rule may specify that a content item should be processed if it has a particular tag or is associated with a particular category. In some cases, based on comparing the content item data and/or content item metadata against the determined automation rule, the upload automation system 100 can detect that the content item no longer meets these conditions.

As mentioned above, the upload automation system 100 can perform the act 502 by tracking specific trigger events and detecting (or flagging) when they do or do not occur. In this context, a trigger event can be designed to initiate an action when a certain event occurs (or does not occur), including, but not limited to, a content item being created, modified, moved, deleted, or otherwise made invalid (e.g., missing content). For instance, the upload automation system 100 can detect that the content item has been modified, moved, or deleted by detecting that the content item data of the content item and/or content item metadata associated with the content item has been modified, moved, or deleted. As an example, the upload automation system 100 may detect that a written document content item has been redacted and/or that a photograph content item has been cropped or inverted.

As also mentioned above, the upload automation system 100 can perform the act 502 by tracking specific expected actions and detecting (or flagging) when they do or do not occur (or do not occur correctly). For instance, the upload automation system 100 can detect when a specified action to, for example, send a communication and/or notification or change an item state does not complete successfully. In at least one embodiment, upon detecting that the specific expected action did not complete successfully, the upload automation system 100 may flag the rule as broken (and provide a corresponding notification). In additional or alternative embodiments, the upload automation system 100 may perform the act 502 in one or more other ways, including by detecting: dependency failures, timeouts or execution delays, permission errors, and/or access denials.

As also illustrated in FIG. 5, the upload automation system 100 performs the act 504 to determine that an automation rule no longer applies. In particular, the upload automation system 100 performs the act 504 in response to performing the act 502.

As further illustrated in FIG. 5, the upload automation system 100 performs the act 506 to determine a fallback automation rule associated with the content item. Specifically, upon performing the act 504, the upload automation system 100 may fallback upon (or revert to) a before determined fallback rule. For example, the before determined fallback rule may be pre-determined by the upload automation system 100 according to the processes outlined above in relation to FIG. 4 and/or it may be selected by a user account or client device. In some embodiments, upon performing the act 504, the upload automation system 100 may again initiate the processes described above in relation to FIG. 4 to perform the act 506.

In at least one embodiment, the fallback automation rule is a default fallback automation rule. In some instances, the upload automation system 100 reverts to one or more other fallback automation rules before reverting to the default fallback automation rule. In the same or other embodiments, the upload automation system 100 reverts to the default fallback automation rule without first reverting to the one or more other fallback automation rules.

In some embodiments, the upload automation system 100 notifies a user account and/or a client device upon performing the act 502. Specifically, upon performing the act 502, the upload automation system 100 can transmit a notification to a user account and/or a client device to inform the user account and/or the client device that an automation rule is broken. In some cases, the upload automation system 100, along with the notification, inquires of the user account and/or the client device whether the user account and/or the client device would like to revert to the default fallback automation rule and/or one or more other fallback automation rules.

In one or more embodiments, the upload automation system 100 may update (or modify) an automation rule upon detecting a change. Specifically, rather than determining a fallback automation rule, the upload automation system 100 may update (or modify) the determined automation rule upon detecting a change to, for example, a user account, team, group, and/or organization that is/are associated with a content item and/or a determined automation rule. Upon detecting the change, the upload automation system 100 can dynamically update or modify the determine automation rule to reflect the change. As an example, if a user account is removed (or otherwise departs from) a team, the upload automation system 100 automatically updates automation rules associated with a content item of the team to revoke the user account's access to that content item. In some cases, the upload automation system 100 provides, for display in a graphical user interface of a client device, one or more mechanisms for updating or modifying an automation rule. For example, the upload automation system 100 updates or modifies the automation rule based on detecting a user interaction with the one or more mechanisms.

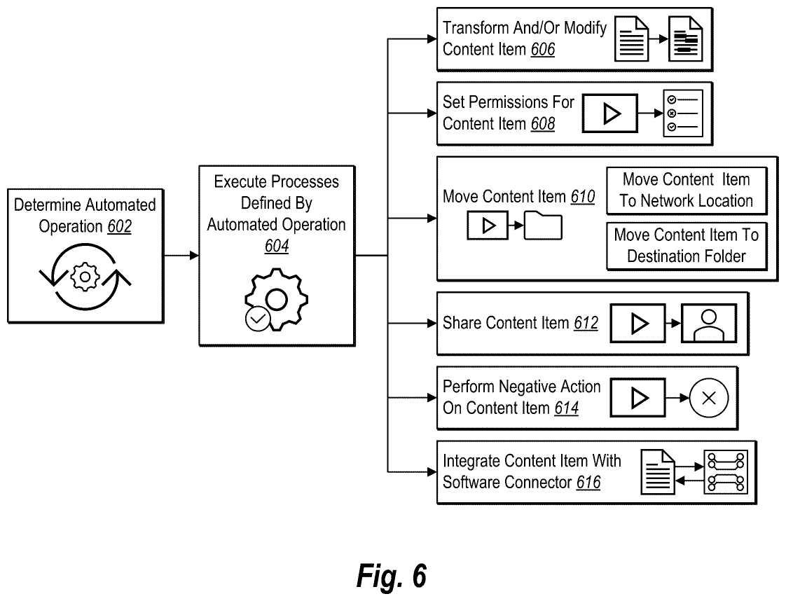

As mentioned above, the upload automation system 100 can execute one or more processes defined by a determined automated operation. In particular, from a determined automation rule, the upload automation system 100 can determine an automated operation and one or more processes defined by the automated operation to execute on a content item. FIG. 6 illustrates an example diagram of executing one or more processes defined by an automated operation in accordance with one or more embodiments.

As shown in FIG. 6, the upload automation system 100 performs an act 602 to determine an automated operation to execute on a content item. In particular, upon determining an automation rule for the content item, the upload automation system 100 can determine one or more operations involved in the automation rule to perform the act 602. As an example, the upload automation system 100 can determine that a determined (or selected) automation rule includes a first automated operation to, upon detecting the upload, move the content item to a destination folder within the content management system. The upload automation system 100 may further determine that the determined automation rule includes a second automated operation to, upon detecting movement to the destination folder, modify (e.g., redact) the content item.

In some embodiments, as part of performing the act 602, the upload automation system 100 can use processed content item data and/or extracted content item metadata to determine one or more purposes for uploading the content item (e.g., to modify in a specific way or to send to a specific user). For instance, the upload automation system 100 can use an automation prediction model to predict the one or more purposes. As an example, the upload automation system 100 uses the automation prediction model to monitor a user account's other content item uploads and actions taken on the other content item uploads to generate predictions for how future content item uploads and automations will likely be performed. In at least one embodiment using the automation prediction model to monitor a user account's other content item uploads and actions taken on the other content item uploads is based on a permission that enables the function. As an example, the upload automation system 100 provides, in a graphical user interface of a client device, a selectable element that can be selected to provide permission to use the automation prediction model in this way.

Based on determining the one or more purposes, the upload automation system 100 can determine and select an automated operation that will execute one or more processes that will satisfy the determined one or more purposes (e.g., by modifying in the specific way or sending to the specific user). In the same or other embodiments, the upload automation system 100 can also perform the act 602 based on other factors, including detecting a trigger event that matches specific criteria and/or using conditional logic to detect and handle a condition that matches specific criteria.

As mentioned, the upload automation system 100 can use conditional logic to detect the happening of a particular condition that matches specific criteria (e.g., if a file is uploaded by a specific user in a certain format). In some embodiments, the upload automation system 100 can determine a specific automated operation that defines one or more processes that, when executed, will satisfy the condition. As an example, a condition could state that if a content item is uploaded and is a PDF created by Angela, and the file size exceeds 25 megabytes, then the content item should be compressed and sent in a notification to John. Continuing this example, if the content item 102 is uploaded, is a PDF, was created by Angela, and exceeds 25 megabytes, the upload automation system 100 can perform the act 602 based on determining that an automated operation that defines processes that, when executed, will compress the content item and send it in a notification to John.

As further illustrated in FIG. 6, the upload automation system 100 performs an act 604 to execute one or more processes defined by the determined automated operation. For instance, the upload automation system 100 can execute one or more processes that include, but are not limited to, moving a content item (e.g., process 610), sharing the content item (e.g., process 612), transforming and/or modifying the content item (e.g., process 606), and/or setting permissions for the content item (e.g., process 608). In the same or other embodiments, the upload automation system 100 can also execute an operation to perform a negative action on the content item (e.g., not performing action to prevent a certain other action or result from occurring) (e.g., process 614) and/or to integrate the content item with a software connector (e.g., process 616). In some cases, the upload automation system 100 performs the act 604 by updating rules based on changes to a user account, team, group, and/or organization as described above in relation to FIG. 5.

As mentioned, the upload automation system 100 can perform the act 604 by executing a process 610 to move the content item. In one or more embodiments, upon detecting an upload of the content item, the upload automation system 100 executes the process 610 by moving the content item from a first network location to a second network location. As used herein, the term “network location” refers to a specific point or endpoint within a network where resources (e.g., data or services) are stored or accessed. A network location can be within a cloud environment, and may be represented by an IP address, a domain name, and/or a virtual storage location. In some cases, a network location is implemented on cloud servers and provides, for access over the internet, remote storage and/or computing capabilities. In some cases, the upload automation system 100 determines the second network location based on using the processed content item data and/or the extracted content item metadata to determine one or more purposes for uploading the content item, as described above.

In the same or other embodiments, the upload automation system 100 executes the process 610 by moving the content item to a destination folder. Specifically, upon detecting the upload of the content item, the upload automation system 100 determines one or more destination folders for the content item. In some cases, the upload automation system 100 determines the destination folder by utilizing a machine learning model (e.g., a large language model (LLM)) to compare a plurality of candidate destination folders with the content item. As an example, the upload automation system 100 can analyze (and/or process) the processed content item data and/or the extracted content item metadata to determine a topic or a theme associated with the content item and/or the content item's subject, purpose, and/or context. Continuing the example, the upload automation system 100 can feed folder data (e.g., descriptions, tags, and/or categories) for the plurality of candidate destination folders into an LLM and utilize the LLM to compare the folder data to the content item data and/or content item metadata. Based on this comparison, the upload automation system 100 can determine one or more destination folders for the content by determining which of the candidate destination folders is/are the most relevant. In some embodiments, upon determine the one or more destination folders for the content item, the upload automation system 100 moves the content item to the one or more destination folders.

As mentioned above, the upload automation system 100 can perform the act 604 by executing a process 612 to share the content item. In particular, the upload automation system 100 can share the content item with one or more user accounts. In some embodiments, the upload automation system 100 shares the content item with one or more teams, groups, and/or organizations. In the same or other embodiments, the upload automation system 100 determines the shared recipients based on using the processed content item data and/or the extracted content item metadata to determine one or more purposes for uploading the content item, as described above.

As also mentioned above, the upload automation system 100 can perform the act 604 by executing a process 606 to transform and/or modify the content item. Specifically, the upload automation system 100 can execute the process 606 in a number of ways, including through redacting information (e.g., redacting sensitive information), extracting information (e.g., extracting key information), creating an otherwise alternative version of the content item (e.g., shortened versions, such as a shortened video clip), renaming a content item, and/or through format conversion (e.g., converting from text to PDF or from .PNG to .JPEG). In some embodiments, the upload automation system 100 executes the process 606 through an image or video modification (e.g., resizing, cropping, applying filters, adjusting brightness, adding watermarks, and/or changing a resolution) or by performing one or more text modifications (e.g., rewriting or rephrasing text). In the same or other embodiments, the upload automation system 100 executes the process 606 through data structuring and cleaning (e.g., text structuring such as adding headings, data normalization, or table conversion), content enrichment (e.g., adding metadata (such as tags), summarizing content, or translating content into other languages), inserting hyperlink embeddings, and/or generating QR codes or other links related to the content item.

As further mentioned above, the upload automation system 100 can perform the act 604 by executing a process 608 to set permissions for the content item. In particular, the upload automation system 100 can set permissions for the content item by defining who (e.g., which user accounts, teams, groups, and/or organizations) can, for example, access, view, edit, and/or share the content item. As an example, the upload automation system 100 can execute the process 608 to set a permission for the content item that defines the content item as set to “view only” for all user accounts in an organization (e.g., all employees of the organization). As another example, the upload automation system 100 can provide “edit” permissions for each user account in the organization to allow the user accounts to edit the content item. In the same or other embodiments, the upload automation system 100 can set other permissions for the content item, including establishing time-limited access (e.g., setting permissions that make the content item accessible only for a limited time, such as for one month or during a specified time window) and/or location-based access (e.g., setting permissions that allow access only when user accounts are within a specific internal network (e.g., a company's internal network) or a specific geographic location).

In one or more embodiments, as mentioned above, the upload automation system 100 performs the act 604 by executing a process 614 to perform a negative action on the content item. Specifically, the upload automation system 100 can execute the process 614 by choosing not to perform a certain action and/or to actively prevent a specific action from executing or occurring (e.g., to avoid an unwanted outcome). To execute the process 614, the upload automation system 100 can detect a requested action and can block it to prevent the action from occurring. In some embodiments, the upload automation system 100 negative actions can be programed as conditional rules such that the upload automation system 100 detects a certain event or trigger before preventing a specific action. As an example, a document marked as “sensitive” may automatically trigger blocking a user account from accessing the document.

In some instances, as mentioned above, the upload automation system 100 performs the act 604 by executing a process 616 to integrate the content item with a software connector. In particular, the upload automation system 100 can generate a code segment (or instruction) to cause an external (or third-party) application, system, and/or server to execute one or more processes defined by an automated operation. For instance, upon generating the code segment, the upload automation system 100 can use a software connector to transmit the code segment to the external application, system, and/or server to cause the external application, system, and/or server to execute the one or more processes. In some embodiments, the upload automation system 100 causes the external application, system, and/or server to execute one or more of the processes 606, 608, 610, 612, and 614. The upload automation system 100 can, in some instances, transmit the content item and/or content item data to the external application, system, and/or server along with the code segment. The upload automation system 100 can additionally or alternatively utilize one or more software connectors to cause an external application, system, and/or server to automatically execute one or more processes based on information from a file synchronization and sharing (FSS) system.

In the same or other embodiments, the upload automation system 100 can utilize a software connector to receive a code segment from the external application, system, and/or server to cause the upload automation system 100 to execute one or more processes defined by an automated operation. In some embodiments, the upload automation system 100 execute one or more of the processes 606, 608, 610, 612, and 614 based on the code segment from the external application, system, and/or server. The upload automation system 100 can, in some cases, receive the content item and/or content item data from the external application, system, and/or server along with the code segment.

In one or more embodiments, the upload automation system 100 utilizes an automation engine to keep a log (or record) of content item uploads and executed processes. In particular, the upload automation system 100 may grant one or more software connectors with access to the automation engine to maintain (or manage) the log. In some instances, the upload automation system 100 can utilize the software connectors and the automation engine to determine a point in time when a content item was uploaded or when a process defined by an automated operation was executed. Based on determining the point in time, the upload automation system 100 can recover (or restore) a deleted content item. In some embodiments, the upload automation system 100 can automatically recover (or restore) (e.g., from the main folder) the deleted content item (e.g., based on enabling a permission). In the same or other embodiments, the upload automation system 100 provides, in a graphical user interface of a client device, a notification and a selectable element to recover (or restore) the deleted content item.

In the same or other embodiments, the upload automation system 100 can execute one or more other processes when performing the act 604. For example, the upload automation system 100 can execute a process to generate a new content item. To elaborate, the upload automation system 100 can generate the new content item based on duplicating an uploaded content item. In the same or other embodiments, the upload automation system 100 can generate the new content item by following rules and/or patterns from previously executed automations. For instance, the upload automation system 100 may determine that, upon upload of a previous, similar content item, an email correspondence was generated, and the previous similar content item was attached to the email correspondence. Based on this determination, the upload automation system 100 can generate another email correspondence for a newly uploaded content item and attach the newly uploaded content item to the email correspondence. In at least one embodiment, the upload automation system 100 can utilize a machine learning model (e.g., an LLM) to generate the new content item.

In one or more embodiments, the upload automation system 100 can execute one or more processes when performing the act 604. For instance, the act 604 can include executing a plurality of processes (e.g., a multi-step or a multi-action series of processes). As an example, the upload automation system 100 may transform a content item, set permission for the transformed content item, and then move that transformed content item to a new destination folder. In some cases, executing the plurality of processes can be in succession (e.g., in an automation chain) (as in the previous example) or simultaneously.

In the same or other cases, the upload automation system 100 performs the plurality of processes automatically in succession based on the upload automation system 100 detecting the triggering of a condition (e.g., executing a process to move the content item upon detecting that the content item was transformed). Additionally or alternatively, the upload automation system 100 can utilize a machine learning model and/or enable a user account to add nested and/or multiple automations (e.g., in the automation chain). In some embodiments, the upload automation system 100 (e.g., via a machine learning model and/or via input from a user account and/or client device) can set one or more entry points and one or more exit points within the automation chain.

In at least one embodiment, the upload automation system 100 can, based on determining the point in time, undo an executed process defined by an automated operation. As an example, upon executing the process 610 to move a content item from a first folder to a destination folder, the upload automation system 100 can undo the movement to the destination folder by moving the content item back to the first folder. In some embodiments, the upload automation system 100 can automatically undo the executed process (e.g., based on enabling a permission). In the same or other embodiments, the upload automation system 100 provides, in a graphical user interface of a client device, a notification and a selectable element to undo the executed process.

In the same or other embodiments, if the upload automation system 100 is unable to execute a process for a content item as defined by an automated operation, the upload automation system 100 places the content item into a main folder (e.g., “all files”). For example, the upload automation system 100 may be unable to execute the process 610 and/or the process 612 if the upload automation system 100 cannot find a destination folder, network location, and/or user account defined in the automation rule (e.g., if the destination folder, network location, and/or user account was deleted). In some instances, upon determining that it will be unable to execute the process, the upload automation system 100 determines a fallback automation rule for the content item, as explained above in relation to FIG. 5.

In some embodiments, the upload automation system 100 provides a review mechanism. In particular, upon determining that an automation rule meets (or fails to meet) a particular rule score and/or secondary rule score (as described above in FIG. 4), the upload automation system 100 can provide, for display in the graphical user interface of a client device, one or more review elements. As an example, upon determining that an automation rule has a rule score and/or a secondary rule score below 60%, the upload automation system 100 may provide one or more review elements for reviewing an executed process defined by an automated operation. Continuing the example, the upload automation system 100 can provide a review element that, upon selecting, approves or disapproves of the executed process (e.g., confirming or denying that a content item was moved to a correct destination folder).

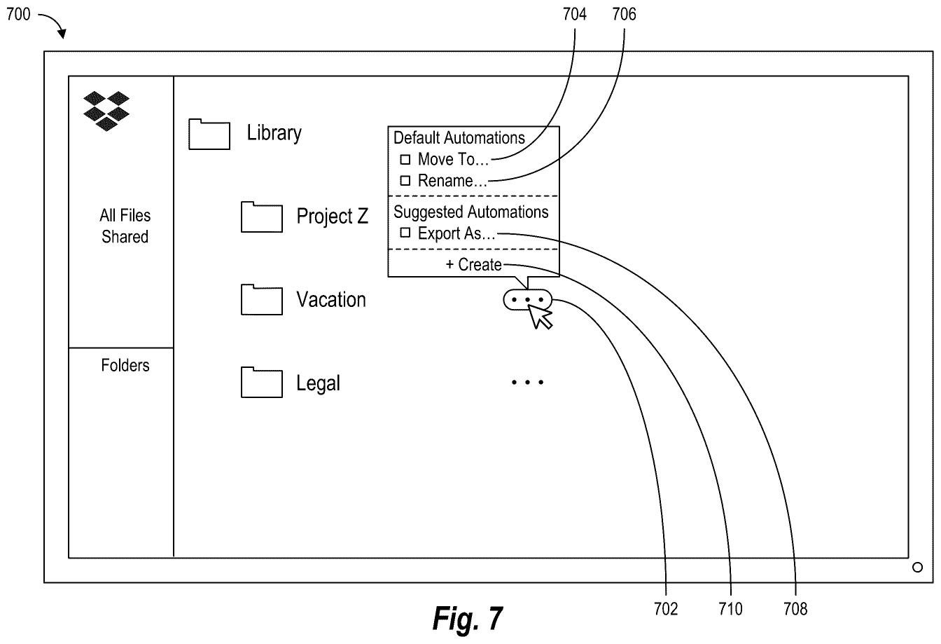

As mentioned above, the upload automation system 100 can generate one or more automation rules. In particular, the upload automation system 100 can generate a default automaton rule, a suggested automation rule, a learned automation rule, and/or a new automation rule. FIG. 7 illustrates an example user interface for generating automation rules in accordance with one or more embodiments.

As illustrated in FIG. 7, the upload automation system 100 provides, for display in a graphical user interface of a client device associated with a user account, a rule generation interface 700. In particular, the upload automation system 100 can provide, in the display of the rule generation interface 700, one or more selectable elements to generate one or more automation rules. In some cases, upon selecting the one or more selectable elements, the upload automation system 100 generates a default automaton rule, a suggested automation rule, a learned automation rule, and/or a new automation rule. In at least one embodiment, the upload automation system 100 provides one or more selectable elements to generate one or more sets of automation rules (e.g., a default set of automation rules).

As also illustrated in FIG. 7, the upload automation system 100 provides a selectable element 702 to display a window for selecting which automation rules to generate. In particular, upon selecting the selectable element 702, the upload automation system 100 can display (or open) a window that provides a listing of various types of automation rules to generate, such as one or more default automaton rules, one or more suggested automation rules, one or more learned automation rules, and/or one or more new automation rule. In one or more embodiments, the upload automation system 100 can provide for selecting which automation rules to generate without the use of the window.

As further illustrated in FIG. 7, the upload automation system 100 provides (e.g., for display in the window) two default automation rules and a suggested automation rule. In particular, the upload automation system 100 can provide for a default automation rule 704 to move a content item and/or a default automation rule 706 to rename a content item. Additionally or alternatively, the upload automation system 100 can provide a suggested automation rule 708 to export a content item. In some embodiments, the upload automation system 100 can provide, in the rule generation interface 700 (e.g., in the window), one or more selectable elements to enable selecting one or more automation rules to generate. As an example, the upload automation system 100 can provide selectable elements to enable selecting one or more of the default automation rule 704, the default automation rule 706, and/or the suggested automation rule 708.

As shown in FIG. 7, the upload automation system 100 includes a mechanism for generating new automation rules. In particular, the upload automation system 100 may provide a selectable (e.g., a selectable element 710) to create a new automation rule (e.g., a custom automation rule). As an example, the upload automation system 100 may provide (e.g., within the window) the selectable element 710 that, upon selection, provides mechanisms to customize and/or determine the parameters of a rule prompt used for generating the new automation rule.

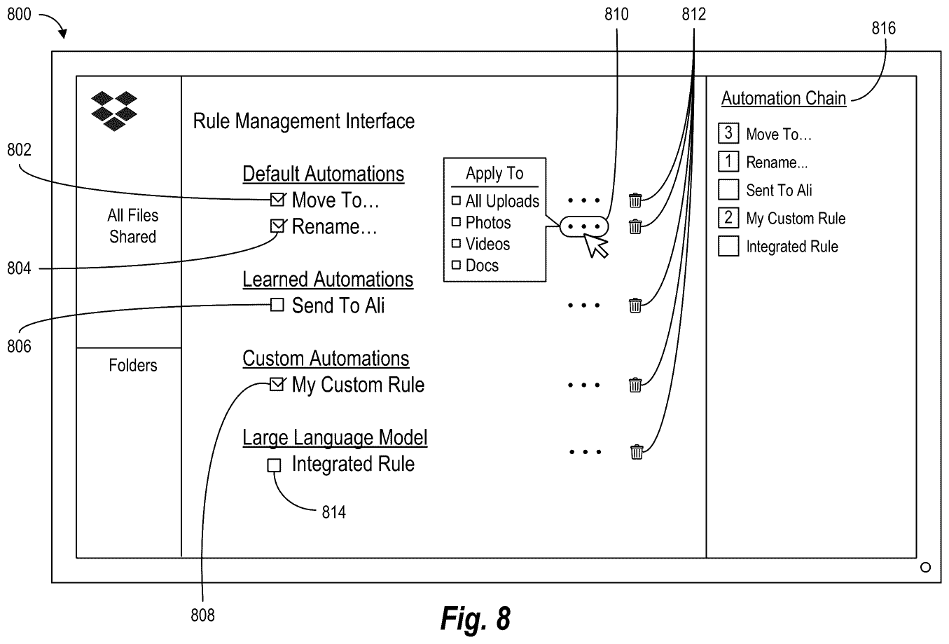

As mentioned above, the upload automation system 100 can generate automation rules and/or import automation rules. In some cases, upon generating and/or importing one or more automation rules, the upload automation system 100 provides for the management of the one or more automation rules. FIG. 8 illustrates an example user interface for managing automation rules in accordance with one or more embodiments.

As illustrated in FIG. 8, the upload automation system 100 provides, for display in a graphical user interface of a client device associated with a user account, a rule management interface 800. In particular, the upload automation system 100 can provide in, the display of the rule management interface 800, one or more rule elements (e.g., selectable elements) to manage one or more automation rules. In some cases, upon selecting the one or more rule elements, the upload automation system 100 manages how generated automation rules and/or imported automation rules will be applied to content items. For instance, the upload automation system 100 can manage a default automaton rule, a suggested automation rule, a learned automation rule, and/or a new automation rule (e.g., a custom automation rule). In the same or other embodiments, the upload automation system 100 provides one or more rule elements to manage one or more sets of automation rules (e.g., a default set of automation rules).

As also illustrated in FIG. 8, the upload automation system 100 can provide, for display in the rule management interface 800, the generated automation rules and/or the imported automation rules. As an example, the upload automation system 100 provides two default automation rules, one learned automation rule, and one custom automation rule. Continuing the example, the upload automation system 100 provides a default automation rule 802 to move a content item, a default automation rule 804 to rename a content item, a learned automation rule 806 to send a content item (e.g., to “Send To Ali”), a custom automation rule 808 to apply a customized automation rule to a content item, and/or an integrated rule 814 that was imported (and/or incorporated) based on integrating with a stored instance of a machine learning model (e.g., a large language model tuned or trained based on user account data and/or previous interactions with the model). In some embodiments, the upload automation system 100 can provide one or more selectable elements within the rule management interface 800 to select one or more automation rules to manage and/or apply. As an example, the upload automation system 100 can provide selectable elements to select one or more of the default automation rule 802, the default automation rule 804, the learned automation rule 806, the custom automation rule 808, and/or the integrated rule 814.

As further illustrated in FIG. 8, the upload automation system 100 provides, within the rule management interface, one or more rule elements for managing selected generated automation rules and/or imported automation rules. In particular, the upload automation system 100 can provide the one or more rule elements to manage how generated automation rules and/or imported automation rules will be applied to content items. For instance, the upload automation system 100 provides rule element 810 to manage the default automation rule 804. Specifically, upon selecting the rule element 810, the upload automation system 100 can open a window that provides one or more other rule elements that, upon their selection, can manage how generated automation rules and/or imported automation rules will be applied to content items.

As an example, upon selecting the rule element 810, the upload automation system 100 provides other rule elements to manage how default automation rule 804 will be applied to content items. Continuing the example, the upload automation system 100 can provide the other rule elements that, upon their selection, apply the default automation rule 804 to all uploaded content items and/or to photograph content items, video content items, and/or document content items. In one or more embodiments, the upload automation system 100 provides for applying an automation rule to all of a specific type of content item (e.g., to all photographs).

In the same or other embodiments, the upload automation system 100 provides more customizability. For example, the upload automation system 100 provides mechanisms for applying an automation rule to select content items within a specific type of content item. To illustrate, the upload automation system 100 can provide mechanisms for applying the automation rule to a select type of photograph (e.g., photographs that have at least a certain number of pixels or can be categorized within a particular topic or theme).

In at least one embodiment, the upload automation system 100 includes an element of retroactivity. In particular, the upload automation system 100 may provide, for display in a graphical user interface of a client device, one or more selectable elements to apply an element of retroactivity to the generated automation rules and/or the imported automation rules. For instance, the upload automation system 100 can provide, in the rule management interface, mechanisms for applying an automation rule to one or more currently uploading content items, one or more future uploaded content items, and/or one or more previously uploaded content items.

As shown in FIG. 8, the upload automation system 100 provides one or more selectable elements for deleting or removing automation rules from the rule management interface 800 and/or from the upload automation system 100. For instance, the upload automation system 100 can provide one or more selectable elements 812 to delete or remove the default automation rule 802, the default automation rule 804, the learned automation rule 806, the custom automation rule 808, and/or the integrated rule 814 from the rule management interface 800 and/or from the upload automation system 100.

As further shown in FIG. 8, the upload automation system 100 can provide one or more selectable elements for determining an order for an automation chain 816 (which is explained above in relation to FIG. 6). Indeed, the upload automation system 100 can generate an automation chain of successive upload automation rules that the upload automation system 100 executes one after the other. For instance, the one or more selectable elements can provide for executing a plurality automations in a specific ordered succession, starting at an entry point and completing at an exit point. As an example, the upload automation system 100 determines that automation rule 804 is first in the automation chain 816, the custom automation rule 808 is second, and the default automation rule 802 is third.

As shown, the upload automation system 100 can include additional automation rules in the automation chain 816 to perform upon upload of a content item. However, upon determining that an automation rule is moot (e.g., that the operations associated with the rules have already been performed), the upload automation system 100 skips the automation rule. The upload automation system 100 can accordingly modify entry points (e.g., initial automation rules) and exit points (final automation rules) specific to individual uploads, even when the same automation chain 816 is applied to each upload.

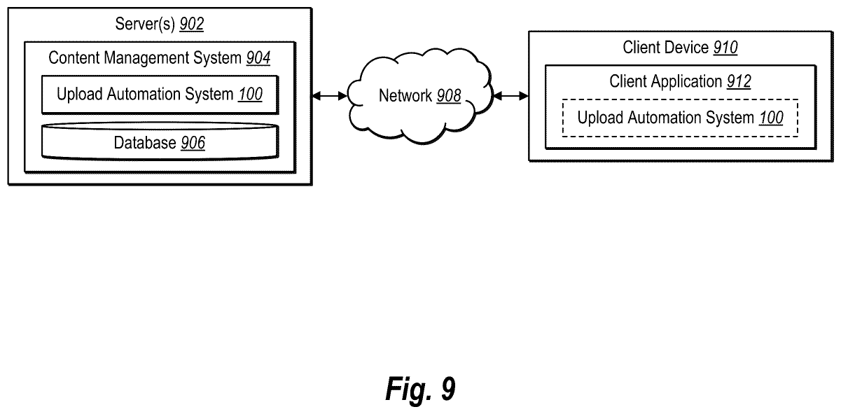

In some embodiments, the upload automation system 100 is part of a networking environment. In particular, the upload automation system 100 is part of a content management system hosted on a distributed networking environment that includes servers and devices communicating one or more a computer networks. For example, FIG. 9 illustrates a diagram of an example environment in which an upload automation system can operate in accordance with one or more embodiments.

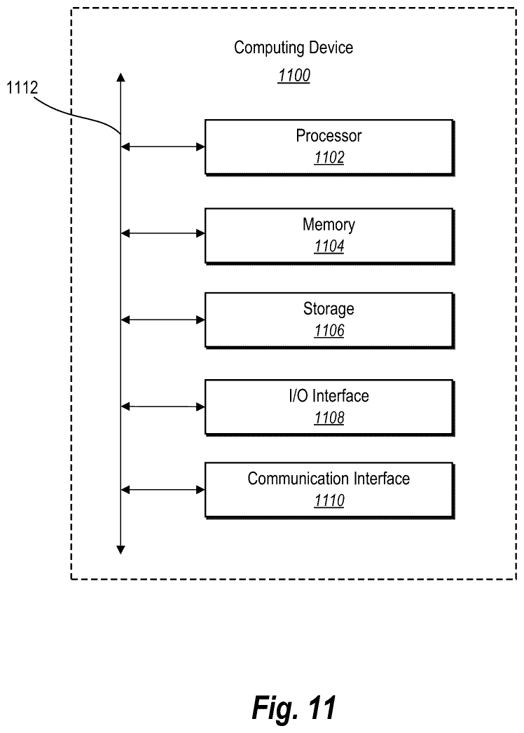

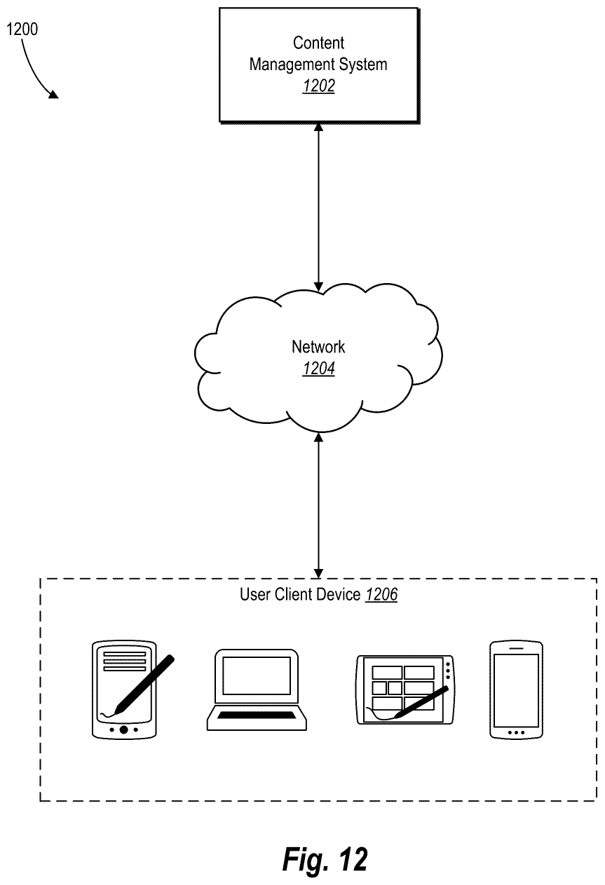

As shown, the environment includes server(s) 902, client device 910, and a network 908. Each of the components of the environment can communicate via the network 908, and the network 908 may be any suitable network over which computing devices can communicate. Example networks are discussed in more detail below in relation to FIGS. 11-12.

As mentioned above, the example environment includes a client device 910. The client device 910 can be one of a variety of computing devices, including a smartphone, a tablet, a smart television, a desktop computer, a laptop computer, a virtual reality device, an augmented reality device, or another computing device as described in relation to FIGS. 11-12. The client device 910 can communicate with the server(s) 902 via the network 908. For example, the client device 910 can receive user input from a user interacting with the client device 910 (e.g., via the client application 912) to, for instance, access, generate, modify, or share a content item, to collaborate with a co-user of a different client device, or to select a graphical user interface element. In addition, the upload automation system 100 on the server(s) 902 can receive information relating to various interactions with content items and/or graphical user interface elements based on the input received by the client device 910 (e.g., to automate functions for a content item upon uploading the content item).

As shown, the client device 910 can include a client application 912. In particular, the client application 912 may be a web application, a native application installed on the client device 910 (e.g., a mobile application, a desktop application, etc.), or a cloud-based application where all or part of the functionality is performed by the server(s) 902. Based on instructions from the client application 912, the client device 910 can present or display information, including a rule generation interface for providing the client device 910 with the ability to generate automation rules and/or a rule management interface for providing the client device 910 with the ability to manage automation rules.

As illustrated in FIG. 9, the example environment also includes the server(s) 902. The server(s) 902 may generate, track, store, process, receive, and transmit electronic data, such as content items, automation rules, interface elements, interactions with and changes to content items, interactions with interface elements, and/or interactions between user accounts or client devices. For example, the server(s) 902 may receive data from the client device 910 in the form of user interactions with interface elements and/or digital data for providing client device 910 with the ability to generate and/or manage automation rules and automating functions for content items upon uploading the content items. In addition, the server(s) 902 can transmit data to the client device 910 in the form of the rule generation interface for providing the client device 910 with the ability to generate automation rules and/or a rule management interface for providing the client device 910 with the ability to manage automation rules. Indeed, the server(s) 902 can communicate with the client device 910 to send and/or receive data via the network 908. In some implementations, the server(s) 902 comprise(s) a distributed server where the server(s) 902 include(s) a number of server devices distributed across the network 908 and located in different physical locations. The server(s) 902 can comprise one or more content servers, application servers, communication servers, web-hosting servers, machine learning server, and other types of servers.

As shown in FIG. 9, the server(s) 902 can also include the upload automation system 100 as part of a content management system 904. The content management system 904 can communicate with the client device 910 to perform various functions associated with the client application 912 such as managing user accounts, managing content collections, managing content items, and facilitating user interaction with the content collections and/or content items. Indeed, the content management system 904 can include a network-based smart cloud storage system to manage, store, and maintain content items and related data across numerous user accounts, including user accounts in collaboration with one another. In some embodiments, the upload automation system 100 and/or the content management system 904 utilize a database 906 to store and access information such as content items, user account behavior data, and automation rules.

Although FIG. 9 depicts the upload automation system 100 located on the server(s) 902, in some implementations, the upload automation system 100 may be implemented by (e.g., located entirely or in part on) one or more other components of the environment. For example, the upload automation system 100 may be implemented by the client device 910 and/or a third-party device. For example, the client device 910 can download all or part of the upload automation system 100 for implementation independent of, or together with, the server(s) 902.

In some implementations, though not illustrated in FIG. 9, the environment may have a different arrangement of components and/or may have a different number or set of components altogether. For example, the client device 910 may communicate directly with the upload automation system 100, bypassing the network 908. As another example, the environment can include the database 906 located external to the server(s) 902 (e.g., in communication via the network 908) or located on the server(s) 902, on a third-party system, and/or on the client device 910. As yet another example, the environment can include a third-party server hosting a large language model in communication with the upload automation system 100.

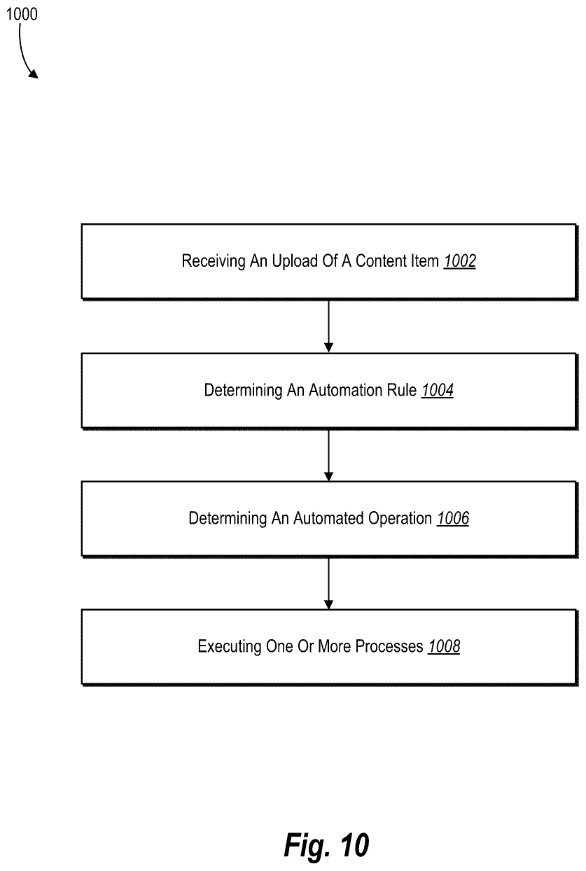

FIGS. 1-9, the corresponding text, and the examples provide a number of different systems and methods for automating functions of content items upon uploading the content items. In addition to the foregoing, implementations can also be described in terms of flowcharts comprising acts steps in a method for accomplishing a particular result. For example, FIG. 10 illustrates an example flowchart of a series of acts for executing one or more processes defined by an automated operation in accordance with one or more embodiments. While FIG. 10 illustrates acts according to certain implementations, alternative implementations may omit, add to, reorder, and/or modify any of the acts shown in FIG. 10. The acts of FIG. 10 can be performed as part of a method. Alternatively, a non-transitory computer readable medium can comprise instructions that, when executed by one or more processors, cause a computing device to perform the acts of FIG. 10. In still further implementations, a system can perform the acts of FIG. 10.

As illustrated in FIG. 10, the series of acts 1000 may include an act 1002 of receiving an upload of a content item. In particular, the act 1002 involves receiving an upload of a content item for a user account at a content management system. The series of acts 1000 can also include an act 1004 of determining an automation rule. In particular, the act 1004 can involve, in response to receiving the upload, determining an upload automation rule associated with the content item by analyzing content item data of the content item in conjunction with a set of upload automation rules associated with the user account. In addition, the series of acts 1000 can include an act 1006 of determining an automated operation. In particular, the act 1006 can involve determining, from the upload automation rule associated with the content item, an automated operation executable on the content item based on the upload of the content item to the content management system irrespective of the location to which the content item was uploaded. Further, the series of acts 1000 can include an act 1008 of executing one or more processes. In particular, the act 1008 can involve executing one or more processes defined by the automated operation associated with the content item.

In some embodiments, the series of acts 1000 includes an act of determining the upload automation rule by: extracting content item metadata associated with the content item prior to receiving a complete upload of the content item; and determining rule scores for the set of upload automation rules based on the content item metadata. The series of acts 1000 can also include an act of determining the upload automation rule by: extracting content item metadata associated with the content item in response to receiving the upload of the content item; and determining rule scores for the set of upload automation rules based on the content item metadata and the content item data of the content item.

In some embodiments, the series of acts 1000 includes an act of determining the upload automation rule by: extracting a topic from the content item utilizing a large language model to process the content item data; and determining rule scores for the set of upload automation rules based on the topic of the content item. In the same or other embodiments, the series of acts 1000 includes an act of generating the upload automation rule by generating a rule prompt interpretable by a large language model to generate the upload automation rule, the rule prompt comprising descriptions of: a set of one or more operations executable upon upload of the content item; and a set of one or more trigger events that, upon detection, cause the large language model to execute one or more operations among the set of one or more operations.

In one or more embodiments, the series of acts 1000 includes an act of providing a default set of upload automation rules associated with user accounts across the content management system; and generating an additional set of upload automation rules for the user account based on historical interactions by the user account with uploaded content items. The series of acts 1000 can also include an act of determining a suggested upload automation rule for the user account based on historical interactions by the user account with content items within the content management system; sending, for display on a client device associated with the user account, a suggestion element corresponding to the suggested upload automation rule and selectable to generate the suggested upload automation rule; and generating the suggested upload automation rule based on detecting a user interaction with the suggestion element.

Additionally, the series of acts 1000 can include an act of determining that no upload automation rule within the set of upload automation rules satisfies a threshold rule score based on comparing the content item data to the set of upload automation rules; in response to determining that no upload automation rule satisfies the threshold rule score, utilizing a secondary machine learning model to generate secondary rule scores for the set of upload automation rules based on a knowledge graph of the content management system; and selecting the upload automation rule associated with the content item based on the secondary rule scores. The series of acts 1000 can also include an act of determining the upload automation rule by importing the upload automation rule from an alternative user account or from a team associated with the user account.

In one or more embodiments, the series of acts 1000 includes an act of determining a rule score for the upload automation rule based on comparing the content item data with the set of upload automation rules; and executing the one or more processes defined by the automated operation in response to determining that the rule score satisfies a rule score threshold. In certain embodiments, the series of acts 1000 includes an act of executing the one or more processes defined by the automated operation by moving the content item from a first network location to a second network location.

In at least one embodiment, the series of acts 1000 includes an act of determining the upload automation rule by: extracting metadata from a second content item prior to receiving the upload of the second content item; and determining rule scores for the set of upload automation rules based on the extracted metadata from the second content item. Additionally, in some cases, the series of acts 1000 can include an act of receiving, from a client device, an indication of user interaction reflecting feedback associated with the automated operation; and based on the indication of the user interaction, modifying parameters of a large language model parameters to improve execution of the automated operation for future instances.

In some embodiments, the series of acts 1000 includes an act of executing the one or more processes defined by the automated operation by executing one or more of: moving the content item, sharing the content item, setting permissions for the content item, performing a negative action on the content item, or integrating the content item with a software connector. The series of acts 1000 can also include an act of executing the one or more processes defined by the automated operation by: determining a destination folder for the content item utilizing a large language model to compare a plurality of candidate destination folders with the content item; and moving the content item to the destination folder.

In one or more embodiments, the series of acts 1000 includes an act of providing, for display on a client device associated with the user account, a rule generation interface that includes a default set of upload automation rules, a suggested upload automation rule, and a mechanism for generating new upload automation rules. The series of acts 1000 can further include an act of providing, for display on a client device associated with the user account, a rule management interface with one or more rule elements selectable to set upload automation rules comprising default upload automation rules, suggested upload automation rules, and learned upload automation rules. In the same or other embodiments, the series of acts 1000 includes an act of determining, in response to modification of the content item, that the upload automation rule no longer applies to the content item; and determining, based on determining that the upload automation rule no longer applies, a fallback upload automation rule associated with the content item.

The components of the upload automation system 100 can include software, hardware, or both. For example, the components of the upload automation system 100 can include one or more instructions stored on a computer-readable storage medium and executable by processors of one or more computing devices. When executed by one or more processors, the computer-executable instructions of the upload automation system 100 can cause a computing device to perform the methods described herein. Alternatively, the components of the upload automation system 100 can comprise hardware, such as a special purpose processing device to perform a certain function or group of functions. Additionally or alternatively, the components of the upload automation system 100 can include a combination of computer-executable instructions and hardware.

Furthermore, the components of the upload automation system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the upload automation system 100 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 (e.g., the server(s) 902 and/or the client device 910) that may be configured to perform one or more of the processes described above. One will appreciate that server(s) 902 and/or the client device 910 may comprise one or more computing devices such as computing device 1100. As shown by FIG. 11, computing device 1100 can comprise processor 1102, memory 1104, storage device 1106, I/O interface 1108, and communication interface 1110, which may be communicatively coupled by way of communication infrastructure 1112. While an example of computing device 1100 is shown in FIG. 11, the components illustrated in FIG. 11 are not intended to be limiting. Additional or alternative components may be used in other implementations. Furthermore, in certain implementations, computing device 1100 can include fewer components than those shown in FIG. 11. Components of computing device 1100 shown in FIG. 11 will now be described in additional detail.

In particular implementations, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular implementations, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage device 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, storage device 1106 can comprise a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to computing device 1100. In particular implementations, storage device 1106 is non-volatile, solid-state memory. In other implementations, storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1108 is configured to provide graphical data to a display for presentation to a user. The graphical data may be representative of one or more graphical user interfaces and/or any other graphical content as may serve a particular implementation.

Communication interface 1110 can include hardware, software, or both. In any event, communication interface 1110 can provide one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 12 is a schematic diagram illustrating environment 1200 within which one or more implementations of the upload automation system 100 can be implemented. For example, the upload automation system 100 may be part of a content management system 1202 (e.g., the content management system 1202). Content management system 1202 may generate, store, manage, receive, and send digital content (such as digital content items). For example, content management system 1202 may send and receive digital content to and from client device 1206 and/or other client devices by way of network 1204. In particular, content management system 1202 can store and manage a collection of digital content. Content management system 1202 can manage the sharing of digital content between computing devices associated with a plurality of users. For instance, content management system 1202 can facilitate a user sharing a digital content with another user of content management system 1202.

In particular, content management system 1202 can manage synchronizing digital content across multiple client devices associated with one or more users. For example, a user may edit digital content using client device 1206. The content management system 1202 can cause client device 1206 to send the edited digital content to content management system 1202. Content management system 1202 then synchronizes the edited digital content on one or more additional computing devices.

In addition to synchronizing digital content across multiple devices, one or more implementations of content management system 1202 can provide an efficient storage option for users that have large collections of digital content. For example, content management system 1202 can store a collection of digital content on content management system 1202, while the client device 1206 only stores reduced-sized versions of the digital content. A user can navigate and browse the reduced-sized versions (e.g., a thumbnail of a digital image) of the digital content on client device 1206. In particular, one way in which a user can experience digital content is to browse the reduced-sized versions of the digital content on client device 1206.

Another way in which a user can experience digital content is to select a reduced-size version of digital content to request the full-or high-resolution version of digital content from content management system 1202. In particular, upon a user selecting a reduced-sized version of digital content, client device 1206 sends a request to content management system 1202 requesting the digital content associated with the reduced-sized version of the digital content. Content management system 1202 can respond to the request by sending the digital content to client device 1206. Client device 1206, upon receiving the digital content, can then present the digital content to the user. In this way, a user can have access to large collections of digital content while minimizing the amount of resources used on client device 1206.

Client device 1206 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1204.

Network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client device 1206 and/or other client devices may access content management system 1202.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

Other figures should describe the invention at its root and include all the different variations or embodiments mentioned in the disclosure documents and the disclosure meeting. Please review the disclosure documents and the disclosure meeting transcript when you are done drafting to make sure that the specification describes all of the features and embodiments disclosed by the inventors.

What is claimed is:

1. A system comprising:
at least one processor; and
at least one non-transitory computer-readable storage medium storing instructions that, when executed by the at least one processor, cause the system to:
receive an upload of a content item for a user account at a content management system;
in response to receiving the upload, determine an upload automation rule associated with the content item by:
extracting content item data from the content item; and
comparing the content item data to a set of upload automation rules associated with the user account;
determine, from the upload automation rule associated with the content item, an automated operation executable on the content item based on the upload of the content item to the content management system irrespective of the location to which the content item was uploaded; and
execute one or more processes defined by the automated operation associated with the content item.

2. The system of claim 1, further comprising instructions that, when executed by the at least one processor, cause the system to:
determine that no upload automation rule within the set of upload automation rules satisfies a threshold rule score based on comparing the content item data to the set of upload automation rules;
in response to determining that no upload automation rule satisfies the threshold rule score, utilizing a secondary machine learning model to generate secondary rule scores for the set of upload automation rules based on a knowledge graph of the content management system; and
selecting the upload automation rule associated with the content item based on the secondary rule scores.

3. The system of claim 1, further comprising instructions that, when executed by the at least one processor, cause the system to determine the upload automation rule by importing the upload automation rule from an alternative user account or from a team associated with the user account.

4. The system of claim 1, further comprising instructions that, when executed by the at least one processor, cause the system to:
determine a rule score for the upload automation rule based on comparing the content item data with the set of upload automation rules; and
execute the one or more processes defined by the automated operation in response to determining that the rule score satisfies a rule score threshold.

5. The system of claim 1, further comprising instructions that, when executed by the at least one processor, cause the system to execute the one or more processes defined by the automated operation by moving the content item from a first network location to a second network location.

6. The system of claim 1, further comprising instructions that, when executed by the at least one processor, cause the system to determine the upload automation rule by:
extracting metadata from a second content item prior to receiving the upload of the second content item; and
determining rule scores for the set of upload automation rules based on the extracted metadata from the second content item.

7. The system of claim 1, further comprising instructions that, when executed by the at least one processor, cause the system to:
receive, from a client device, an indication of user interaction reflecting feedback associated with the automated operation; and
based on the indication of the user interaction, modify parameters of a large language model parameters to improve execution of the automated operation for future instances.

8. A computer-implemented method comprising:
receiving an upload of a content item for a user account at a content management system;
in response to receiving the upload, determining an upload automation rule associated with the content item by analyzing content item data of the content item in conjunction with a set of upload automation rules associated with the user account;
determining, from the upload automation rule associated with the content item, an automated operation executable on the content item based on the upload of the content item to the content management system irrespective of the location to which the content item was uploaded; and
executing one or more processes defined by the automated operation associated with the content item.

9. The computer-implemented method of claim 8, wherein determining the upload automation rule comprises:
extracting content item metadata associated with the content item prior to receiving a complete upload of the content item; and
determining rule scores for the set of upload automation rules based on the content item metadata.

10. The computer-implemented method of claim 8, wherein determining the upload automation rule comprises:
extracting content item metadata associated with the content item in response to receiving the upload of the content item; and
determining rule scores for the set of upload automation rules based on the content item metadata and the content item data of the content item.

11. The computer-implemented method of claim 8, wherein determining the upload automation rule comprises:
extracting a topic from the content item utilizing a large language model to process the content item data; and
determining rule scores for the set of upload automation rules based on the topic of the content item.

12. The computer-implemented method of claim 8, further comprising generating the upload automation rule by generating a rule prompt interpretable by a large language model to generate the upload automation rule, the rule prompt comprising descriptions of:
a set of one or more operations executable upon upload of the content item; and
a set of one or more trigger events that, upon detection, cause the large language model to execute one or more operations among the set of one or more operations.

13. The computer-implemented method of claim 8, further comprising:
providing a default set of upload automation rules associated with user accounts across the content management system; and
generating an additional set of upload automation rules for the user account based on historical interactions by the user account with uploaded content items.

14. The computer-implemented method of claim 8, further comprising:
determining a suggested upload automation rule for the user account based on historical interactions by the user account with content items within the content management system;
sending, for display on a client device associated with the user account, a suggestion element corresponding to the suggested upload automation rule and selectable to generate the suggested upload automation rule; and
generating the suggested upload automation rule based on detecting a user interaction with the suggestion element.

15. A non-transitory computer-readable medium storing instructions that, when executed by at least one processor, cause a computer system to:
receive an upload of a content item for a user account at a content management system;
in response to receiving the upload, determine an upload automation rule associated with the content item by determining, for a set of upload automation rules associated with the user account, upload automation rule scores based on comparing content item data of the content item to the set of upload automation rules;
determine, from the upload automation rule associated with the content item, an automated operation executable on the content item based on the upload of the content item to the content management system irrespective of the location to which the content item was uploaded; and
execute one or more processes defined by the automated operation associated with the content item.

16. The computer-readable medium of claim 15, further comprising instructions that, when executed by the at least one processor, cause the computer system to execute the one or more processes defined by the automated operation by executing one or more of: moving the content item, sharing the content item, setting permissions for the content item, performing a negative action on the content item, or integrating the content item with a software connector.

17. The computer-readable medium of claim 15, further comprising instructions that, when executed by the at least one processor, cause the computer system to execute the one or more processes defined by the automated operation by:
determining a destination folder for the content item utilizing a large language model to compare a plurality of candidate destination folders with the content item; and
moving the content item to the destination folder.

18. The computer-readable medium of claim 15, further comprising instructions that, when executed by the at least one processor, cause the computer system to provide, for display on a client device associated with the user account, a rule generation interface that includes a default set of upload automation rules, a suggested upload automation rule, and a mechanism for generating new upload automation rules.

19. The computer-readable medium of claim 15, further comprising instructions that, when executed by the at least one processor, cause the computer system to provide, for display on a client device associated with the user account, a rule management interface with one or more rule elements selectable to set upload automation rules comprising default upload automation rules, suggested upload automation rules, and learned upload automation rules.

20. The computer-readable medium of claim 15, further comprising instructions that, when executed by the at least one processor, cause the computer system to:
determine, in response to modification of the content item, that the upload automation rule no longer applies to the content item; and
determine, based on determining that the upload automation rule no longer applies, a fallback upload automation rule associated with the content item.
